(19) United States
(12) Patent Application Publication
(10) Pub. No.: US 2012/0251767 A1
(43) Pub. Date: Oct. 4, 2012

(54) HONEYCOMB STRUCTURE

(75) Inventors: Shigeharu Ishikawa, Ibi-gun (JP); Shigeaki Goto, Ibi-gun (JP); Toyoki Ogasawara, Ibi-gun (JP)

(73) Assignee: IBIDEN CO., LTD., Ogaki-shi (JP)

(21) Appl. No.: 13/288,965

(22) Filed: Nov. 4, 2011

(30) Foreign Application Priority Data
Mar. 31, 2011 (JP) PCT/JP2011/058334

(51) Int. Cl. B32B 3/12; B29C 65/48

(52) U.S. Cl. 428/116; 156/296

(57) ABSTRACT

A honeycomb structure includes a plurality of honeycomb fired bodies. Each of the plurality of honeycomb fired bodies is combined with one another by an adhesive layer interposed between the honeycomb fired bodies to form a ceramic body. Each of the honeycomb fired bodies has a peripheral wall around each of the honeycomb fired bodies and has a plurality of cells each of which extends along a longitudinal direction of the honeycomb fired body and in parallel with one another. The cells are separated from one another with a cell wall disposed between the cells. The ceramic body includes at least one center-high-heat-capacity honeycomb fired body which is a honeycomb fired body having a heat capacity per unit volume in a central part in a plane perpendicular to the longitudinal direction larger than a heat capacity per unit volume in a peripheral part in the plane.

### CROSS-REFERENCE TO RELATED APPLICATIONS

The present application claims priority under 35 U.S.C. §119 to International Application No. PCT/JP2011/058334 filed on Mar. 31, 2011, the contents of which are incorporated herein by reference in their entirety.

### BACKGROUND OF THE INVENTION

1. Field of the Invention

The present invention relates to a honeycomb structure.

2. Discussion of the Background

In recent years, particulates (hereinafter, also referred to as “PM”) such as soot and other toxic components contained in exhaust gases discharged from internal combustion engines of vehicles such as buses and trucks, construction machines, or the like have raised serious problems as contaminants harmful to the environment and the human body.

For this reason, various honeycomb structured bodies made of porous ceramics have been proposed as honeycomb filters to purify the exhaust gases.

Conventionally-known honeycomb structured bodies as above described include a honeycomb structure having a ceramic block including a combination of multiple honeycomb fired bodies in each of which a large number of cells are longitudinally disposed in parallel with one another with a cell wall interposed therebetween.

JP-A 2003-10616 discloses a honeycomb structure including honeycomb fired bodies in which a heat capacity per unit volume in a peripheral part of the honeycomb fired body is larger than a heat capacity per unit volume in a central part of the honeycomb fired body in order to improve resistance to cracks caused by a thermal stress. Specifically, JP-A 2003-10616 discloses a honeycomb structure including honeycomb fired bodies in each of which the average thickness of the cell walls in the peripheral part is larger than the average thickness of the cell walls in the central part.

The contents of JP-A 2003-10616 are incorporated herein by reference in their entirety.

### SUMMARY OF THE INVENTION

According to one aspect of the present invention, a honeycomb structure includes a plurality of honeycomb fired bodies. Each of the plurality of honeycomb fired bodies is combined with one another by an adhesive layer interposed between the honeycomb fired bodies to form a ceramic body. Each of the honeycomb fired bodies has a peripheral wall around each of the honeycomb fired bodies and has a plurality of cells each of which extends along a longitudinal direction of the honeycomb fired body and in parallel with one another. The cells are separated from one another with a cell wall disposed between the cells. The ceramic body includes at least one center-high-heat-capacity honeycomb fired body which is a honeycomb fired body having a heat capacity per unit volume in a central part in a plane perpendicular to the longitudinal direction larger than a heat capacity per unit volume in a peripheral part in the plane.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a perspective view schematically illustrating one example of a honeycomb structure of a first embodiment of the present invention. FIG. 1B is an A-A line cross-sectional view of the honeycomb structure illustrated in FIG. 1A.

FIG. 2A is a perspective view schematically illustrating one example of an inner honeycomb fired body in the honeycomb structure of the first embodiment of the present invention. FIG. 2B is a B-B line cross-sectional view of the inner honeycomb fired body illustrated in FIG. 2A.

FIG. 3 is a cross-sectional view schematically illustrating a central part and a peripheral part of a honeycomb fired body in the honeycomb structure of one embodiment of the present invention.

FIG. 4 is a side view of the inner honeycomb fired body illustrated in FIGS. 2A and 2B.

FIGS. 5A and 5B are side views each schematically illustrating one example of an outer honeycomb fired body in the honeycomb structure of the first embodiment of the present invention.

FIG. 6A is a side view schematically illustrating, from one end face side, one example of an inner honeycomb fired body in a honeycomb structure of a second embodiment of the present invention. FIG. 6B is a side view schematically illustrating, from the other end face side, the inner honeycomb fired body illustrated in FIG. 6A.

FIG. 7 is a side view schematically illustrating another example of an inner honeycomb fired body in the honeycomb structure of the second embodiment of the present invention.

FIG. 8 is a side view schematically illustrating another example of an inner honeycomb fired body in the honeycomb structure of the second embodiment of the present invention.

FIG. 9 is a side view schematically illustrating one example of an inner honeycomb fired body in a honeycomb structure of a third embodiment of the present invention.

FIGS. 10A and 10B are side views each schematically illustrating another example of an inner honeycomb fired body in the honeycomb structure of the third embodiment of the present invention.

FIG. 11 is a side view schematically illustrating one example of an inner honeycomb fired body in a honeycomb structure of a fourth embodiment of the present invention.

FIG. 12 is a side view schematically illustrating another example of an inner honeycomb fired body in the honeycomb structure of the fourth embodiment of the present invention.

FIG. 13 is a schematic view for explaining a method of measuring the thickness of a cell wall in a honeycomb fired body in each of the examples and comparative examples.

FIGS. 14A and 14B are side views each schematically illustrating one example of an outer honeycomb fired body in a honeycomb structure of another embodiment of the present invention.

FIG. 15A is a side view schematically illustrating another example of an inner honeycomb fired body in the honeycomb structure of the first embodiment of the present invention. FIG. 15B is a side view schematically illustrating another example of an inner honeycomb fired body in the honeycomb structure of the second embodiment of the present invention.

FIGS. 16A and 16B are side views each schematically illustrating one example of an inner honeycomb fired body in a honeycomb structure of another embodiment of the present invention.

FIG. 17 is a perspective view schematically illustrating one example of a honeycomb structure of another embodiment of the present invention.

### DESCRIPTION OF THE EMBODIMENTS

In the conventional honeycomb structure described in JP-A 2003-10616, cell walls in a peripheral part of a honeycomb fired body are thicker than cell walls in a central part of the honeycomb fired body, presumably leading to high resistance to external stress.

In embodiments of the present invention, it is allowed to provide a honeycomb structure that tends not to generate cracks in the case where the honeycomb structure has a high temperature.

A honeycomb structure according to the embodiments of the present invention includes: a ceramic block in which multiple honeycomb fired bodies are combined with one another by interposing an adhesive layer, the honeycomb fired bodies having a peripheral wall therearound and having a large number of cells longitudinally disposed in parallel with one another with a cell wall therebetween, wherein at least one of the multiple honeycomb fired bodies is a center-high-heat-capacity honeycomb fired body in which a heat capacity per unit volume in a central part of the honeycomb fired body is larger than a heat capacity per unit volume in a peripheral part of the honeycomb fired body.

The honeycomb structure according to the embodiments of the present invention includes a center-high-heat-capacity honeycomb fired body in which the heat capacity per unit volume in the central part of the honeycomb fired body is larger than the heat capacity per unit volume in the peripheral part of the honeycomb fired body.

Therefore, in the case where the honeycomb structure has a high temperature, temperature tends not to increase in the central part of the center-high-heat-capacity honeycomb fired body. In contrast, temperature tends to increase in the peripheral part of the center-high-heat-capacity honeycomb fired body. However, heat tends to be emitted around the high-heat-capacity honeycomb fired body (to an adhesive layer, or to a peripheral coat layer in the case where the peripheral coat layer is formed). Accordingly, since the temperature difference in between the central part and the peripheral part of the center-high-heat-capacity honeycomb fired body tends to be suppressed, cracks resulting from the temperature difference tend to be prevented. Consequently, cracks tend not to occur in the honeycomb structure.

In the present description, the expression “a cell wall in the honeycomb fired body” refers to a portion that is present between adjacent two cells to separate the two cells. The expression “a peripheral wall in the honeycomb fired body” refers to a portion that is present around the honeycomb fired body and forms the periphery of the honeycomb fired body.

The expression “a central part of the honeycomb fired body” used herein refers to a part in which a cross section perpendicular to a longitudinal direction of the honeycomb fired body includes the center of the cross section of the honeycomb fired body, and which is surrounded by a similar figure to the periphery of the cross section of the honeycomb fired body and accounts for about 50% of the cross section of the honeycomb fired body. The expression “a peripheral part of the honeycomb fired body” used herein refers to a part that is located outside the central part of the honeycomb fired body and is other than the central part and the peripheral wall in the honeycomb fired body.

In addition, the expression “a heat capacity per unit volume” used herein refers to a heat capacity based on the volume containing cells.

In the honeycomb structure according to the embodiments of the present invention, an average thickness of the cell walls in the central part of the center-high-heat-capacity honeycomb fired body is preferably larger than an average thickness of the cell walls in the peripheral part of the center-high-heat-capacity honeycomb fired body.

When the average thickness of the cell walls in the central part of the center-high-heat-capacity honeycomb fired body is larger than the average thickness of the cell walls in the peripheral part of the center-high-heat-capacity honeycomb fired body, the heat capacity per unit volume in the central part of the center-high-heat-capacity honeycomb fired body tends to be larger than the heat capacity per unit volume in the peripheral part of the center-high-heat-capacity honeycomb fired body. Accordingly, since the temperature difference in between the central part and the peripheral part of the center-high-heat-capacity honeycomb fired body tends to be suppressed, cracks resulting from the temperature difference tend to be prevented.

The case where the honeycomb structure according to the embodiments of the present invention is used for collecting PM in exhaust gases is desirable in terms of the following points.

Pressure loss tends to be comparatively small in portions in which cell walls of the honeycomb fired body are thin. In the honeycomb structure according to the embodiments of the present invention, since the average thickness of the cell walls in the peripheral part of the center-high-heat-capacity honeycomb fired body is smaller than the average thickness of the cell walls in the central part of the center-high-heat-capacity honeycomb fired body, exhaust gases are more likely allowed to flow into the peripheral part of the center-high-heat-capacity honeycomb fired body. As a result, PM is more likely to be deposited in the peripheral part than in the central part of the center-high-heat-capacity honeycomb fired body.

Therefore, in the case where such a honeycomb structure according to the embodiments of the present invention is used for collecting PM in exhaust gases, heating in the central part of the center-high-heat-capacity honeycomb fired body tends to be comparatively small upon burning PM during the regenerating treatment. In contrast, in the peripheral part of the center-high-heat-capacity honeycomb fired body, since the amount of deposited PM is large, the heat quantity tends to be comparatively large. Further, since the heat capacity is small, the temperature in the peripheral part of the center-high-heat-capacity honeycomb fired body tends to increase. However, in the peripheral part of the center-high-heat-capacity honeycomb fired body, heat tends to be emitted around the center-high-heat-capacity honeycomb fired body (to an adhesive layer, or to a peripheral coat layer in the case where the peripheral coat layer is formed). Accordingly, since the temperature difference in between the central part and the peripheral part of the center-high-heat-capacity honeycomb fired body tends to be more reduced, cracks tend to be prevented.

In the honeycomb structure according to the embodiments of the present invention, the average thickness of the cell walls in the central part of the center-high-heat-capacity honeycomb fired body is preferably from about 0.10 mm to about 0.20 mm, and the average thickness of the cell walls in the peripheral part of the center-high-heat-capacity honeycomb fired body is preferably from about 90% to about 98% of the average thickness of the cell walls in the central part of the center-high-heat-capacity honeycomb fired body.

If the average thickness of the cell walls in the central part of the center-high-heat-capacity honeycomb fired body is about 0.10 mm or more, the heat capacity per unit volume in the central part of the center-high-heat-capacity honeycomb fired body is not too small. Therefore, it is more likely to prevent a temperature rise in the central part of the center-high-heat-capacity honeycomb fired body. As a result, if the honeycomb structure has a high temperature, cracks are less likely to occur in the honeycomb structure. If the average thickness of the cell walls in the central part of the center-high-heat-capacity honeycomb fired body is about 0.10 mm or more, the average thickness of the cell walls in the peripheral part of the center-high-heat-capacity honeycomb fired body tends not to be less than about 0.10 mm. Therefore, the strength of the honeycomb fired body is more likely to be secured.

In contrast, if the average thickness of the cell walls in the central part of the center-high-heat-capacity honeycomb fired body is about 0.20 mm or less, the heat capacity per unit volume in the central part of the center-high-heat-capacity honeycomb fired body tends not to be large. Therefore, the effect of preventing a temperature rise in the central part of the center-high-heat-capacity honeycomb fired body tends not to be improved. However, when the cell wall is not too thick, the filtration pressure of exhaust gases passing through the cell wall tends not to rise, and therefore pressure loss, another required performance as the honeycomb structure, is less likely to increase.

If the average thickness of the cell walls in the peripheral part of the center-high-heat-capacity honeycomb fired body is about 90% or more of the average thickness of the cell walls in the central part of the center-high-heat-capacity honeycomb fired body, the strength of the honeycomb fired body is more likely to be secured.

In contrast, if the average thickness of the cell walls in the peripheral part of the center-high-heat-capacity honeycomb fired body is about 98% or less of the average thickness of the cell walls in the central part of the center-high-heat-capacity honeycomb fired body, the difference in the average thickness of the cell walls in between the central part and the peripheral part of the center-high-heat-capacity honeycomb fired body tends not to be small. Accordingly, since the difference in heat capacity per unit volume in between the central part and the peripheral part of the center-high-heat-capacity honeycomb fired body tends not to be small, the effect of reducing the temperature difference in between the central part and the peripheral part of the center-high-heat-capacity honeycomb fired body is more likely to be obtained.

In the honeycomb structure according to the embodiments of the present invention, the thickness of the cell wall may gradually decrease from the central part to the peripheral part of the center-high-heat-capacity honeycomb fired body.

In the honeycomb structure according to the embodiments of the present invention, the thickness of the cell wall may continuously decrease from the central part to the peripheral part of the center-high-heat-capacity honeycomb fired body.

In the honeycomb structure according to the embodiments of the present invention, it may be easier to gradually or continuously decrease the heat capacity per unit volume in the center-high-heat-capacity honeycomb fired body from the central part to the peripheral part of the center-high-heat-capacity honeycomb fired body. Therefore, heat tends to be transferred smoothly from the central part to the peripheral part of the center-high-heat-capacity honeycomb fired body.

Then, heat tends to be emitted around the center-high-heat-capacity honeycomb fired body (to an adhesive layer, or to a peripheral coat layer in the case where the peripheral coat layer is formed). As a result, since the temperature difference in between the central part and the peripheral part of the center-high-heat-capacity honeycomb fired body tends to be more reduced, cracks tend to be prevented.

The expression “the thickness of the cell wall gradually decreases” used herein means that when the relationship between the thickness of the cell wall and the length thereof perpendicular to the thickness direction is plotted, the thickness of the cell wall discontinuously decreases stepwise (two or more steps). The expression “the thickness of the cell wall continuously decreases” used herein means that when the relationship between the thickness of the cell wall and the length thereof perpendicular to the thickness direction is plotted, the thickness of the cell wall decreases in a curved or straight manner.

In the honeycomb structure according to the embodiments of the present invention, cell walls located in the outermost part of the center-high-heat-capacity honeycomb fired body are preferably thinner than cell walls other than the cell walls located in the outermost part of the center-high-heat-capacity honeycomb fired body.

In such a honeycomb structure, the heat capacity per unit volume in the outermost part of the center-high-heat-capacity honeycomb fired body tends to be smaller than the heat capacity per unit volume in a part other than the outermost part. Therefore, the temperature in the outermost part of the center-high-heat-capacity honeycomb fired body tends to rise. Since the temperature difference in between the central part and the peripheral part of the center-high-heat-capacity honeycomb fired body tends to be more reduced even in the honeycomb structure including the center-high-heat-capacity honeycomb fired bodies having such a configuration, cracks tend to be prevented.

In the honeycomb structure according to the embodiments of the present invention, the thickness of the peripheral wall is preferably from about 0.20 mm to about 0.50 mm in each of the multiple honeycomb fired bodies.

If the thickness of the peripheral wall is about 0.20 mm or more, the strength of the honeycomb fired body is more likely to be secured.

If the thickness of the peripheral wall is about 0.50 mm or less, the weight of the entire honeycomb structure tends not to increase though the weight reduction is desired.

In the honeycomb structure according to the embodiments of the present invention, in each of the multiple honeycomb fired bodies, the large number of cells preferably include large volume cells and small volume cells, and each of the large volume cells is preferably larger than each of the small volume cells in a cross section perpendicular to the longitudinal direction.

In the honeycomb structure according to the embodiments of the present invention, each of the large volume cells may have a substantially octagonal shape in a cross section perpendicular to the longitudinal direction, and each of the small volume cells may have a substantially quadrangle shape in a cross section perpendicular to the longitudinal direction.

In the honeycomb structure according to the embodiments of the present invention, each of the large volume cells may have a substantially quadrangle shape in a cross section perpendicular to the longitudinal direction, and each of the small volume cells may have a substantially quadrangle shape in a cross section perpendicular to the longitudinal direction.

In the honeycomb structure according to the embodiments of the present invention, a cell wall to define each of the large volume cells and the small volume cells may have a shape formed by a curve line in a cross section perpendicular to the longitudinal direction.

In the case where the honeycomb structure according to the embodiments of the present invention is used for collecting PM in exhaust gases, a large amount of PM tends to be collected in the large volume cells. Therefore, the temperature of the honeycomb fired bodies tends to rise upon burning PM during the regenerating treatment. However, in the honeycomb structure according to the embodiments of the present invention, since the temperature difference in between the central part and the peripheral part of the center-high-heat-capacity honeycomb fired body tends to be reduced, cracks tend to be prevented.

In the honeycomb structure according to the embodiments of the present invention, the symmetry between a large volume cell in a cross section and a small volume cell in a cross section tends to be improved, likely resulting in improvement in isostatic strength and compressive strength of the honeycomb fired body. Therefore, when the honeycomb structure has a high temperature, cracks tend to be prevented in the honeycomb structure also in terms of the strength.

In the case where such a honeycomb structure is used for collecting PM in exhaust gases, the symmetry between a large volume cell and a small volume cell is improved, whereby exhaust gases are more easily allowed to flow into the large volume cells in a balanced manner.

In the honeycomb structure according to the embodiments of the present invention, the ratio of the area of each of the large volume cells in a cross section perpendicular to the longitudinal direction to the area of each of the small volume cells in a cross section perpendicular to the longitudinal direction is preferably from about 1.4 to about 2.8.

If the area ratio is about 1.4 or more, the difference between the area of each of the large volume cells in a cross section and the area of each of the small volume cells in a cross section tends not to be small, and therefore the effect of providing the large volume cells and small volume cells is more likely to be exerted. In contrast, if the area ratio is about 2.8 or less, the rate of cell walls separating large volume cells tends not to be high. As a result, in the case where such a honeycomb structure is used for collecting PM in exhaust gases, exhaust gases are more likely to pass through the cell walls separating large volume cells, and therefore pressure loss, another required performance as the honeycomb structure, is less likely to increase.

In the honeycomb structure according to the embodiments of the present invention, all of the honeycomb fired bodies not located in the periphery of the ceramic block are preferably the center-high-heat-capacity honeycomb fired bodies.

In such a honeycomb structure, in the case where exhaust gases flow into the honeycomb structure, and thereby the central part of the honeycomb structure has a high temperature, the temperature difference in between the central part and the peripheral part of the center-high-heat-capacity honeycomb fired body tends to be reduced because all of the honeycomb fired bodies located in the central part of the honeycomb structure are center-high-heat-capacity honeycomb fired bodies. Therefore, cracks tend to be prevented in the honeycomb structure.

In the honeycomb structure according to the embodiments of the present invention, all of the multiple honeycomb fired bodies are preferably the center-high-heat-capacity honeycomb fired bodies.

In such a honeycomb structure, all of the honeycomb fired bodies in the honeycomb structure are the center-high-heat-capacity honeycomb fired bodies, the temperature difference in between the central part and the peripheral part of the center-high-heat-capacity honeycomb fired bodies tends to be reduced. Therefore, temperature tends to be uniform in the entire honeycomb structure. Accordingly, cracks tend to be more prevented in the honeycomb structure.

In the honeycomb structure according to the embodiments of the present invention, the large number of cells are preferably alternately sealed at either end portions in each of the multiple honeycomb fired bodies.

It is possible to suitably use such a honeycomb structure as a filter for collecting PM in exhaust gases.

The embodiments will now be described with reference to the accompanying drawings, wherein like reference numerals designate corresponding or identical elements throughout the various drawings. However, the present invention is not limited to the following embodiments, and the embodiments may be appropriately changed and applied to the present invention as long as the gist of the present invention are not changed.

### First Embodiment

Hereinafter, a first embodiment that is one embodiment of the honeycomb structure of the present invention will be described with reference to drawings.

The honeycomb structure according to the first embodiment of the present invention includes: a ceramic block in which multiple honeycomb fired bodies are combined with one another by interposing an adhesive layer, the honeycomb fired bodies having a peripheral wall therearound and having a large number of cells longitudinally disposed in parallel with one another with a cell wall therebetween, wherein at least one of the multiple honeycomb fired bodies is a center-high-heat-capacity honeycomb fired body in which a heat capacity per unit volume in a central part of the honeycomb fired body is larger than a heat capacity per unit volume in a peripheral part of the honeycomb fired body.

In the honeycomb structure according to the first embodiment of the present invention, all of the honeycomb fired bodies not located in the periphery of the ceramic block are the center-high-heat-capacity honeycomb fired bodies.

Hereinafter, a honeycomb fired body located in the periphery of the ceramic block is referred to as “an outer honeycomb fired body”, and a honeycomb fired body located inward of the outer honeycomb fired body is referred to as “an inner honeycomb fired body”. Both the outer honeycomb fired body and the inner honeycomb fired body are simply referred to as the honeycomb fired body in the case that it is not necessary to distinguish them from each other.

In the present description, simple phrases of a cross section of the honeycomb structure, a cross section of the honeycomb fired body, and a cross section of the honeycomb molded body refer to a cross section perpendicular to the longitudinal direction of the honeycomb structure, a cross section perpendicular to the longitudinal direction of the honeycomb fired body, and a cross section perpendicular to the longitudinal direction of the honeycomb molded body. Further, a simple phrase of the cross-sectional area of the honeycomb fired body refers to the area of the cross section perpendicular to the longitudinal direction of the honeycomb fired body.

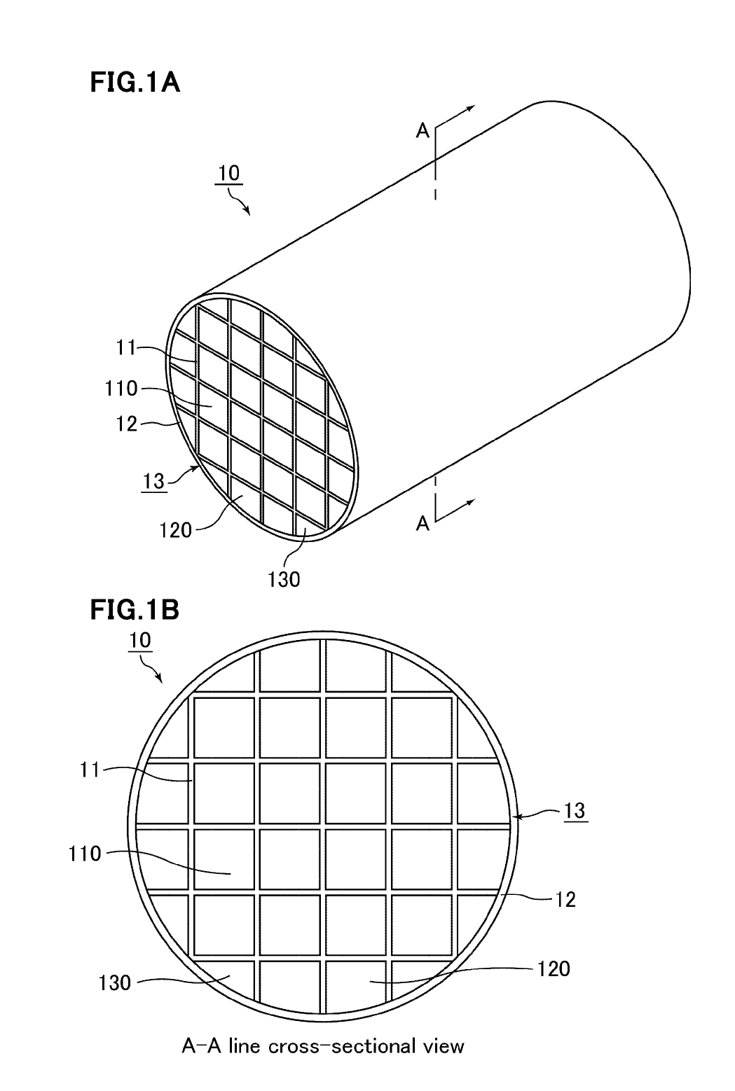

FIG. 1A is a perspective view schematically illustrating one example of a honeycomb structure of a first embodiment of the present invention. FIG. 1B is an A-A line cross-sectional view of the honeycomb structure illustrated in FIG. 1A.

In a honeycomb structure 10 illustrated in FIGS. 1A and 1B, multiple honeycomb fired bodies 110, 120, and 130 are bound with adhesive layers 11 interposed therebetween to form a ceramic block 13. Additionally, the ceramic block 13 has a peripheral coat layer 12 formed on its periphery. Here, the peripheral coat layer may be formed according to need.

The honeycomb fired bodies 110, 120, and 130 in the honeycomb structure 10, which will be described later, are preferably porous bodies including silicon carbide or silicon-bonded silicon carbide.

In the honeycomb structure 10 illustrated in FIGS. 1A and 1B, 8 pieces of outer honeycomb fired bodies 120 and 8 pieces of outer honeycomb fired bodies 130 are positioned to form the periphery of the ceramic block 13 and 16 pieces of inner honeycomb fired bodies 110 are positioned inward of the honeycomb fired bodies 120 and 130. A total of the 32 pieces of the honeycomb fired bodies are combined with one another by interposing the adhesive layers 11 in a manner such that the ceramic block 103 (the honeycomb structure 10) forms a circular cross-sectional shape.

As illustrated in FIG. 1B, the inner honeycomb fired body 110 has a substantially quadrangle (substantially square) cross-sectional shape.

Also, as illustrated in FIG. 1B, the cross-sectional shape of the outer honeycomb fired body 120 is a shape surrounded by three line segments and one substantially arc shape. Both of the two angles formed by two line segments out of the three line segments are substantially 90°.

Further, as illustrated in FIG. 1B, the cross-sectional shape of the outer honeycomb fired body 130 is a shape surrounded by two line segments and one substantially arc shape. The angle formed by the two line segments is substantially 90°.

Hereinafter, honeycomb fired bodies (inner honeycomb fired bodies and outer honeycomb fired bodies) in the honeycomb structure according to the first embodiment of the present invention will be described with reference to drawings.

First, the inner honeycomb fired body in the honeycomb structure according to the first embodiment of the present invention will be described.

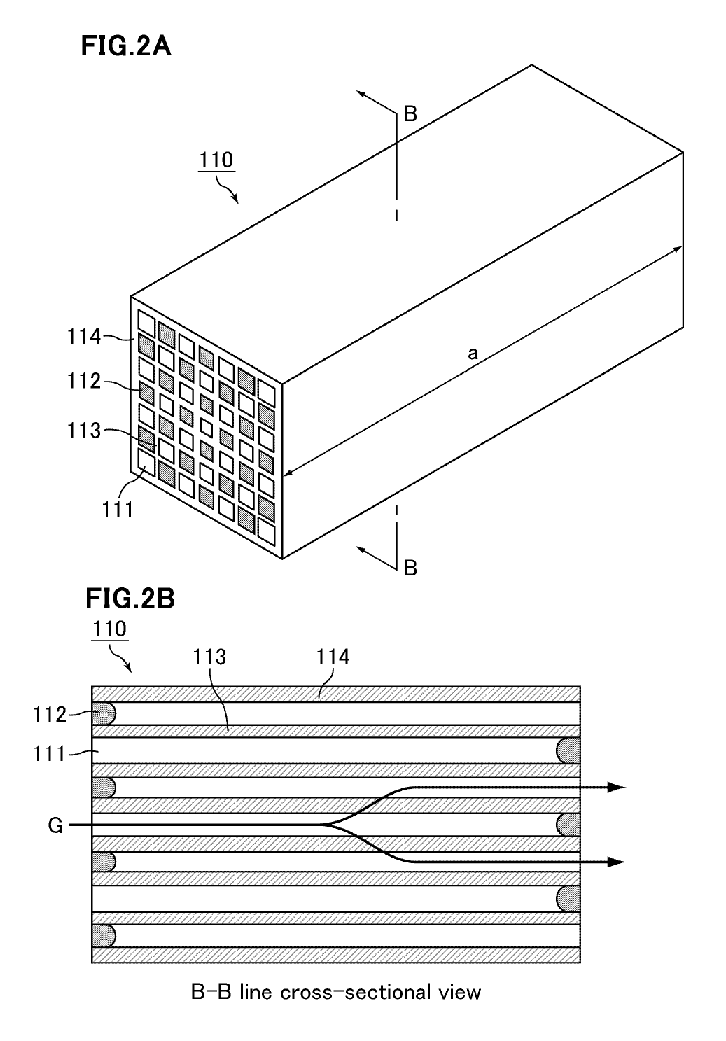

FIG. 2A is a perspective view schematically illustrating one example of an inner honeycomb fired body in the honeycomb structure of the first embodiment of the present invention. FIG. 2B is a B-B line cross-sectional view of the inner honeycomb fired body illustrated in FIG. 2A.

An inner honeycomb fired body 110 illustrated in FIGS. 2A and 2B has a large number of cells 111 disposed in parallel with one another in a longitudinal direction (direction of arrow “a” in FIG. 2A) with a cell wall 113 therebetween, and a peripheral wall 114 is formed around the inner honeycomb fired body 110. In addition, either one end portion of each of the cells 111 is sealed with a plug material 112.

Therefore, exhaust gases G (exhaust gases are indicated by “G” and the flow of the exhaust gases are indicated by arrows in FIG. 2B) which have flowed into one of the cells 111 with an opening on one end face surely pass through the cell wall 113 separating the cells 111, and flow out from another cell 111 with an opening on the other end face. When the exhaust gases G pass through the cell wall 113, the cell wall 113 captures PM and the like in the exhaust gases. Thus, the cell wall 113 functions as a filter.

In the honeycomb structure according to the first embodiment of the present invention, all of the honeycomb fired bodies not located in the periphery of the ceramic block (that is, the inner honeycomb fired bodies) are center-high-heat-capacity honeycomb fired bodies in each of which the heat capacity per unit volume in the central part of the honeycomb fired body is larger than the heat capacity per unit volume in the peripheral part of the honeycomb fired body.

Hereinafter, the central part and the peripheral part of the honeycomb fired body will be described.

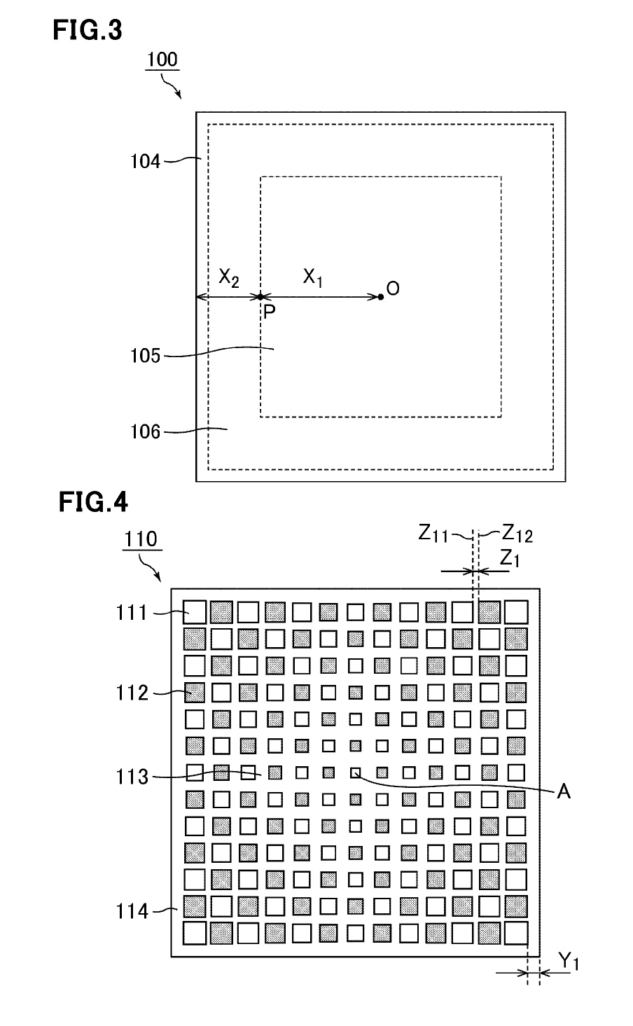

FIG. 3 is a cross-sectional view schematically illustrating the central part and the peripheral part of the honeycomb fired body in the honeycomb structure of one embodiment of the present invention. In FIG. 3, cells and cell walls are omitted for convenience. Two dashed lines are illustrated in FIG. 3; the inner dashed line represents a boundary between the central part and the peripheral part of the honeycomb fired body, and the outer dashed line represents a boundary between the peripheral part and the peripheral wall of the honeycomb fired body.

As described above, the expression “a central part of the honeycomb fired body” used herein refers to a part, in which a cross section perpendicular to the longitudinal direction of the honeycomb fired body includes the center of the cross section of the honeycomb fired body, and which is surrounded by a similar figure to the periphery of the cross section of the honeycomb fired body and accounts for about 50% of the cross section of the honeycomb fired body. In contrast, the expression “a peripheral part of the honeycomb fired body” used herein refers to a part that is located outside the central part of the honeycomb fired body, and is other than the central part and the peripheral wall in the honeycomb fired body.

With reference to FIG. 3, a central part 105 of a honeycomb fired body 100 refers to a part in which a cross section perpendicular to a longitudinal direction of the honeycomb fired body 100 includes a center of the cross section of the honeycomb fired body 100 (in FIG. 3, “O” represents the center of the cross section of the honeycomb fired body), a part surrounded by a line made by connecting points which internally divides the line segment connecting the center “O” and the periphery in a ratio of about 1:about (2^{1/2}-1), that is, points that satisfy the equation X₁:X₂=about 1:about (2^{1/2}-1) (in FIG. 3, “P” represents the internally dividing point). In contrast, in FIG. 3, a peripheral part 106 of the honeycomb fired body 100 refers to a part located outside the central part 105 of the honeycomb fired body 100, and is other than the central part 105 and a peripheral wall 104 of the honeycomb fired body 100.

Here, FIG. 3 describes the case where the honeycomb fired body has a substantially quadrangle (substantially square) cross-sectional shape. The central part and the peripheral part of the honeycomb fired body are determined by the above relationship irrespective of the cross-sectional shape of the honeycomb fired body.

In the honeycomb structure according to the first embodiment of the present invention, in order to make the heat capacity per unit volume in the central part of the center-high-heat-capacity honeycomb fired body larger than the heat capacity per unit volume in the peripheral part of the center-high-heat-capacity honeycomb fired body, the average thickness of the cell walls in the central part of the center-high-heat-capacity honeycomb fired body is made larger than the average thickness of the cell walls in the peripheral part of the center-high-heat-capacity honeycomb fired body.

More specifically, in the honeycomb structure according to the first embodiment of the present invention, the thickness of the cell wall gradually decreases from the central part to the peripheral part of the center-high-heat-capacity honeycomb fired body.

FIG. 4 is a side view of the inner honeycomb fired body illustrated in FIGS. 2A and 2B.

As illustrated in FIG. 4, in the inner honeycomb fired body 110, the average thickness of the cell walls in the central part of the inner honeycomb fired body 110 is larger than the average thickness of the cell walls in the peripheral part of the inner honeycomb fired body 110.

Specifically, in the inner honeycomb fired body 110 illustrated in FIG. 4, the thickness of the cell wall 113 gradually decreases from the central part to the peripheral part of the inner honeycomb fired body 110.

Therefore, the inner honeycomb fired body 110 illustrated in FIG. 4 is a center-high-heat-capacity honeycomb fired body in which the heat capacity per unit volume in the central part of the honeycomb fired body is larger than the heat capacity per unit volume in the peripheral part of the honeycomb fired body.

Here, in FIG. 4, “Z₁” indicates the thickness of the cell wall 113 of the inner honeycomb fired body 110. Thus, the expression “the thickness of the cell wall in the honeycomb fired body” refers to the shortest length among the lengths between two adjacent cells.

The thickness of the cell wall in the honeycomb fired body is measured by the following method. By the following measuring method, the thickness of the cell wall can be measured even in the case where the shapes of the cell lines to be measured are not constant.

First, a measuring instrument for reading a digital stage position is attached on the stage of an optical microscope (produced by Nikon Corporation, measuring microscope MM-40), and thereafter a sample (honeycomb fired body), a measuring object, is fixed to the stage.

Next, a microscope is focused on one side (side positioned in “Z₁₁” in FIG. 4) of one cell of a cell wall to be measured.

Subsequently, the stage is moved, and the microscope is focused on one side (side positioned in “Z₁₂” in FIG. 4) of the other cell of a cell wall.

Then, the distance in which the stage has been moved is read, and the distance is regarded as the thickness of the cell wall.

As illustrated in FIG. 4, all of the cells 111 in the honeycomb fired body 110 have substantially quadrangle (substantially square) shapes in a cross section perpendicular to the longitudinal direction.

In the inner honeycomb fired body 110 illustrated in FIG. 4, a cell located in the center of the cross section of the honeycomb fired body (a cell located in the position “A” in FIG. 4) is the smallest, and the size of a cell increases as the distance gets farther from the center of the cross section of the honeycomb fired body.

Hereinafter, a method for calculating the heat capacity per unit volume in the central part of the honeycomb fired body will be described.

First, the area of the cell wall located in the central part of the honeycomb fired body is measured with an optical microscope. Next, the area of the entire central part of the honeycomb fired body including cells is measured. Subsequently, the ratio of the area of the cell wall to the area of the entire central part of the honeycomb fired body (hereinafter, also referred to as a cell wall ratio) is determined. Then, the heat capacity per unit volume in the central part of the honeycomb fired body is determined by the following formula (1).

Heat capacity per unit volume in the central part of the honeycomb fired body/(J/(K·m³))={cell wall ratio (%)/100}×density of the material of the cell wall (kg/m³)×specific heat of the material of the cell wall (J/kg·K) (1)

The heat capacity per unit volume in the peripheral part of the honeycomb fired body can also be determined by the same method. Here, as described above, the peripheral part of the honeycomb fired body does not include the peripheral wall in the honeycomb fired body.

In the honeycomb structure according to the first embodiment of the present invention, as long as the thickness of the cell wall gradually decreases from the central part to the peripheral part of the center-high-heat-capacity honeycomb fired body, the shape of the cell wall is not limited to the shape illustrated in FIG. 4.

In the honeycomb structure according to the first embodiment of the present invention, the average thickness of the cell walls in the central part of the center-high-heat-capacity honeycomb fired body is preferably from about 0.10 mm to about 0.20 mm, and more preferably from about 0.12 mm to about 0.18 mm.

If the average thickness of the cell walls in the central part of the center-high-heat-capacity honeycomb fired body is about 0.10 mm or more, the heat capacity per unit volume in the central part of the center-high-heat-capacity honeycomb fired body is not too small. Therefore, it may be easier to prevent a temperature rise in the central part of the center-high-heat-capacity honeycomb fired body. As a result, if the honeycomb structure has a high temperature, cracks are less likely to occur in the honeycomb structure. If the average thickness of the cell walls in the central part of the center-high-heat-capacity honeycomb fired body is about 0.10 mm or more, the average thickness of the cell walls in the peripheral part of the center-high-heat-capacity honeycomb fired body tends not to be less than about 0.10 mm. Therefore, the strength of the honeycomb fired body is more likely to be secured.

In contrast, if the average thickness of the cell walls in the central part of the center-high-heat-capacity honeycomb fired body is about 0.20 mm or less, the heat capacity per unit volume in the central part of the center-high-heat-capacity honeycomb fired body is not too large. Therefore, the effect of preventing a temperature rise in the central part of the center-high-heat-capacity honeycomb fired body tends not to be improved. However, when the cell wall is not too thick, the filtration pressure of exhaust gases passing through the cell wall tends not to rise, and therefore pressure loss, another required performance as the honeycomb structure, is less likely to increase.

In the honeycomb structure according to the first embodiment of the present invention, the average thickness of the cell walls in the peripheral part of the center-high-heat-capacity honeycomb fired body is preferably from about 90% to about 98% and more preferably from about 92% to about 96% of the average thickness of the cell walls in the central part of the center-high-heat-capacity honeycomb fired body.

If the average thickness of the cell walls in the peripheral part of the center-high-heat-capacity honeycomb fired body is about 90% or more of the average thickness of the cell walls in the central part of the center-high-heat-capacity honeycomb fired body, the strength of the honeycomb fired body is more likely to be secured.

In contrast, if the average thickness of the cell walls in the peripheral part of the center-high-heat-capacity honeycomb fired body is about 98% or less of the average thickness of the cell walls in the central part of the center-high-heat-capacity honeycomb fired body, the difference in the average thickness of the cell walls in between the central part and the peripheral part of the center-high-heat-capacity honeycomb fired body tends not to be small. Accordingly, since the difference in heat capacity per unit volume in between the central part and the peripheral part of the center-high-heat-capacity honeycomb fired body tends not to be small, the effect of reducing the temperature difference in between the central part and the peripheral part of the center-high-heat-capacity honeycomb fired body is more likely to be obtained.

Hereinafter, the method of measuring the average thickness of the cell walls in the central part and the peripheral part of the honeycomb fired body will be described.

First, the thickness of the cell wall in a cell line of a cell (cells) located closest to the center of the cross section of the honeycomb fired body is measured at predetermined intervals with an optical microscope by the aforementioned method. This measurement is made in cell lines in different two directions (for example, a longitudinal direction, a transverse direction, and the like). Then, the average thicknesses of the cell walls measured are calculated in the central part and the peripheral part of the honeycomb fired body, and the obtained values are regarded as the average thicknesses in the central part and the peripheral part of the honeycomb fired body.

Next, an outer honeycomb fired body in the honeycomb structure of the first embodiment of the present invention will be described.

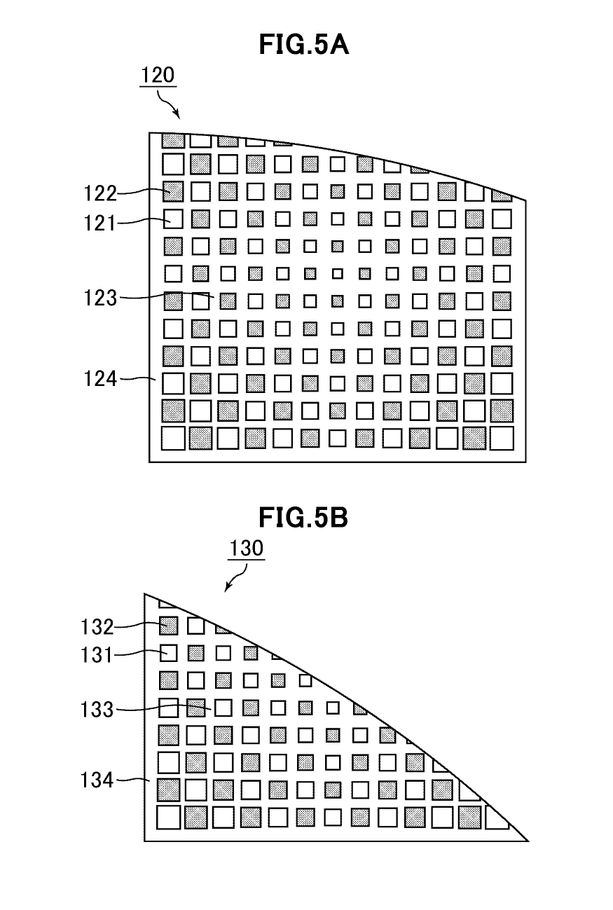

FIGS. 5A and 5B are side views each schematically illustrating one example of the outer honeycomb fired body in the honeycomb structure of the first embodiment of the present invention.

An outer honeycomb fired body 120 illustrated in FIG. 5A and an outer honeycomb fired body 130 illustrated in FIG. 5B have a cross-sectional shape excluding part of the inner honeycomb fired body 110 illustrated in FIGS. 2A, 2B, and 4.

This is because upon manufacturing the honeycomb structure 10 illustrated in FIGS. 1A and 1B, as described below, multiple honeycomb fired bodies 110 having shapes illustrated in FIGS. 2A, 2B, and 4 are combined with one another to manufacture a substantially rectangular pillar-shaped ceramic block, and thereafter the periphery of the substantially rectangular pillar-shaped ceramic block is cut to form a substantially round pillar-shaped ceramic block.

Therefore, the outer honeycomb fired body 120 illustrated in FIG. 5A and the outer honeycomb fired body 130 illustrated in FIG. 5B have the same configuration as that of the inner honeycomb fired body 110 illustrated in FIGS. 2A, 2B and 4, except that the cross-sectional shapes are different. Here, in the outer honeycomb fired body 120 illustrated in FIG. 5A and the outer honeycomb fired body 130 illustrated in FIG. 5B, the cut portions have no peripheral wall.

In the honeycomb structure according to the first embodiment of the present invention, the thickness of the peripheral wall in each of the honeycomb fired bodies (inner honeycomb fired bodies and outer honeycomb fired bodies) is preferably from about 0.20 mm to about 0.50 mm, and more preferably from about 0.25 mm to about 0.40 mm.

If the thickness of the peripheral wall in the honeycomb fired body is about 0.20 mm or more, the strength of the honeycomb fired body is more likely to be secured. In contrast, if the thickness of the peripheral wall in the honeycomb fired body is about 0.50 mm or less, the weight of the entire honeycomb structure tends not to increase though weight reduction is desired.

Here, in FIG. 4, “Y₁” indicates the thickness of the peripheral wall 114 of the inner honeycomb fired body 110. Thus, the expression “the thickness of the peripheral wall in the honeycomb fired body” refers to the shortest length among the lengths between cells located in the outermost part of the honeycomb fired body and the periphery of the honeycomb fired body. Here, the thickness of the peripheral wall in the honeycomb fired body can be measured by the same method for measuring the thickness of the cell wall in the honeycomb fired body.

Next, a method for manufacturing the honeycomb structure according to the first embodiment of the present embodiment will be described. Here, a case will be described where silicon carbide is used as ceramic powder.

(1) A wet mixture containing ceramic powder and a binder is extrusion-molded to manufacture a honeycomb molded body (molding process).

Specifically, silicon carbide powders having different average particle sizes as ceramic powder, an organic binder, a liquid plasticizer, a lubricant, and water are mixed to prepare a wet mixture for manufacturing a honeycomb molded body.

Then, the wet mixture is charged into an extrusion molding machine and extrusion-molded to manufacture honeycomb molded bodies in predetermined shapes.

Here, a honeycomb molded body is manufactured with a die that can make the cross-sectional shape having a cell structure (the shape and arrangement of cells) illustrated in FIG. 4. The die is provided with a groove for forming cell walls of a honeycomb molded body. A honeycomb molded body having a predetermined cross-sectional shape can be manufactured by electrically discharging, polishing the groove of the die, and the like.

(2) Next, the honeycomb molded bodies are cut at a predetermined length and dried with use of a drying apparatus such as a microwave drying apparatus, a hot-air drying apparatus, a dielectric drying apparatus, a reduced-pressure drying apparatus, a vacuum drying apparatus, and a freeze drying apparatus. Then, predetermined cells are sealed by filling the cells with a plug material paste to be a plug material (sealing process).

Here, the wet mixture may be used as the plug material paste.

(3) Then, the honeycomb molded body is heated in a degreasing furnace to remove organic matters in the honeycomb molded body (degreasing process). The degreased honeycomb molded body is transferred to a firing furnace and fired (firing process). In this manner, the honeycomb fired body as illustrated in FIGS. 2A, 2B, and 4 is manufactured.

The sealing material paste filled into the end portion of the cells is fired by heating to be a sealing material.

Conditions for cutting, drying, sealing, degreasing, and firing may be conditions conventionally used for manufacturing honeycomb fired bodies.

(4) Next, an adhesive paste is applied to predetermined side faces of the honeycomb fired bodies, which have cells each sealed at a predetermined end portion, to form adhesive paste layers. The adhesive paste layers are heated and solidified to form adhesive layers, whereby a ceramic block in which multiple honeycomb fired bodies are combined by interposing an adhesive layer is formed (combining process).

Here, the adhesive paste contains, for example, an inorganic binder, an organic binder, and inorganic particles. The adhesive paste may further contain at least one of an inorganic fiber and a whisker.

(5) A periphery cutting process is carried out to cut the ceramic block (periphery cutting process).

Specifically, the periphery of the ceramic block is cut with a diamond cutter, whereby a ceramic block whose periphery is cut into a substantially round pillar shape is manufactured.

(6) Further, a peripheral coating material paste is applied to the peripheral face of the substantially round pillar-shaped ceramic block, and is dried and solidified to form a peripheral coat layer (peripheral coat layer forming process).

The adhesive paste may be used as the peripheral coating material paste. Or alternatively, the peripheral coating material paste may be a paste having a composition different from that of the adhesive paste.

It is to be noted that the peripheral coat layer is not necessarily formed and may be formed according to need.

In this manner, it is possible to manufacture the honeycomb structure according to the first embodiment of the present invention.

Hereinafter, the effects of the honeycomb structure according to the first embodiment of the present invention are listed.

(1) The honeycomb structure according to the present embodiment includes center-high-heat-capacity honeycomb fired bodies in each of which the heat capacity per unit volume in the central part of the honeycomb fired body is larger than the heat capacity per unit volume in the peripheral part of the honeycomb fired body.

Therefore, in the case where the honeycomb structure has a high temperature, temperature tends not to increase in the central part of a center-high-heat-capacity honeycomb fired body. In contrast, temperature tends to increase in the peripheral part of the center-high-heat-capacity honeycomb fired body. However, heat tends to be emitted around the high-heat-capacity honeycomb fired body (to an adhesive layer, or to a peripheral coat layer in the case where the peripheral coat layer is formed). Accordingly, since the temperature difference in between the central part and the peripheral part of the center-high-heat-capacity honeycomb fired body tends to be suppressed, cracks resulting from the temperature difference tend to be prevented. Consequently, cracks tend not to occur in the honeycomb structure.

(2) In the honeycomb structure of the present embodiment, the average thickness of the cell walls in the central part of the center-high-heat-capacity honeycomb fired body is larger than the average thickness of the cell walls in the peripheral part of the center-high-heat-capacity honeycomb fired body.

When the average thickness of the cell walls in the central part of the center-high-heat-capacity honeycomb fired body is larger than the average thickness of the cell walls in the peripheral part of the center-high-heat-capacity honeycomb fired body, the heat capacity per unit volume in the central part of the center-high-heat-capacity honeycomb fired body tends to be larger than the heat capacity per unit volume in the peripheral part of the center-high-heat-capacity honeycomb fired body.

(3) Pressure loss tends to be comparatively small in portions in which the cell walls of the honeycomb fired bodies are thin. In the honeycomb structure according to the present embodiment, since the average thickness of the cell walls in the peripheral part of the center-high-heat-capacity honeycomb fired body is smaller than the average thickness of the cell walls in the central part of the center-high-heat-capacity honeycomb fired body, exhaust gases are more likely allowed to flow into the peripheral part of the center-high-heat-capacity honeycomb fired body. As a result, PM is more likely to be deposited in the peripheral part than in the central part of the center-high-heat-capacity honeycomb fired body.

Therefore, in the case where the honeycomb structure according to the present embodiment is used for collecting PM in exhaust gases, heating in the central part of the center-high-heat-capacity honeycomb fired body tends to be comparatively small upon burning PM during the regenerating treatment. In contrast, in the peripheral part of the center-high-heat-capacity honeycomb fired body, since the amount of deposited PM is large, the heat quantity tends to be comparatively large. Further, since the heat capacity is small, the temperature in the peripheral part of the center-high-heat-capacity honeycomb fired body tends to increase. However, in the peripheral part of the center-high-heat-capacity honeycomb fired body, heat tends to be emitted around the center-high-heat-capacity honeycomb fired body (to an adhesive layer, or to a peripheral coat layer in the case where the peripheral coat layer is formed). Accordingly, since the temperature difference in between the central part and the peripheral part of the center-high-heat-capacity honeycomb fired body tends to be more reduced, cracks tend to be prevented.

(4) In the honeycomb structure of the present embodiment, the thickness of the cell wall gradually decreases from the central part to the peripheral part of the center-high-heat-capacity honeycomb fired body.

In the honeycomb structure of the present embodiment, the heat capacity per unit volume in the center-high-heat-capacity honeycomb fired body tends to be gradually decreased from the central part to the peripheral part of the center-high-heat-capacity honeycomb fired body. Therefore, heat tends to be transferred smoothly from the central part to the peripheral part of the center-high-heat-capacity honeycomb fired body.

(5) In the honeycomb structure of the present embodiment, all of the honeycomb fired bodies not located in the periphery of the ceramic block are the center-high-heat-capacity honeycomb fired bodies.

In the honeycomb structure of the present embodiment, in the case where exhaust gases flow into the honeycomb structure, and thereby the central part of the honeycomb structure has a high temperature, the temperature difference in between the central part and the peripheral part of the center-high-heat-capacity honeycomb fired body tends to be reduced because all of the honeycomb fired bodies located in the central part of the honeycomb structure are the center-high-heat-capacity honeycomb fired bodies. Therefore, cracks tend to be prevented in the honeycomb structure.

### Second Embodiment

Hereinafter, a second embodiment that is one embodiment of the present invention will be described.

Inner honeycomb fired bodies and outer honeycomb fired bodies in the honeycomb structure according to the second embodiment of the present invention have the same configurations as those of the inner honeycomb fired bodies and outer honeycomb fired bodies in the honeycomb structure according to the first embodiment of the present invention. In addition, the combination of the inner honeycomb fired bodies and outer honeycomb fired bodies in the ceramic block (honeycomb structure) is the same as that of the first embodiment of the present invention.

Further, in the honeycomb structure according to the second embodiment of the present invention, as in the honeycomb structure according to the first embodiment of the present invention, all of the honeycomb fired bodies not located in the periphery of the ceramic block (namely, inner honeycomb fired bodies) are the center-high-heat-capacity honeycomb fired bodies.

In the second embodiment of the present invention, in each of the honeycomb fired bodies (inner honeycomb fired bodies and outer honeycomb fired bodies) in the honeycomb structure, a large number of cells include large volume cells and small volume cells, and each of the large volume cells is larger than each of the small volume cells in a cross section perpendicular to the longitudinal direction.

First, an inner honeycomb fired body in the honeycomb structure of the second embodiment of the present invention will be described.

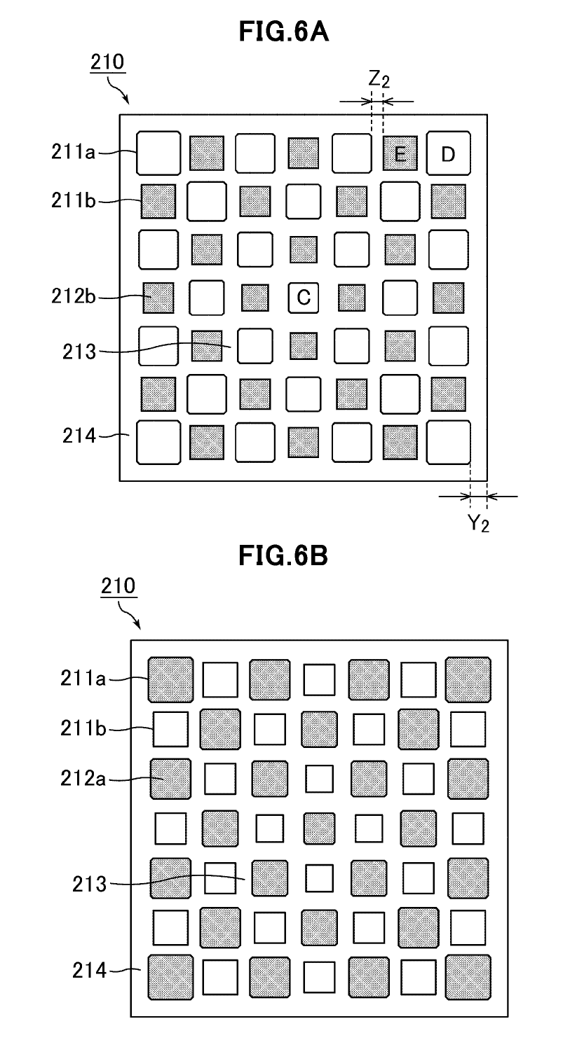

FIG. 6A is a side view schematically illustrating, from one end face side, one example of an inner honeycomb fired body in a honeycomb structure of a second embodiment of the present invention. FIG. 6B is a side view schematically illustrating, from the other end face side, the inner honeycomb fired body illustrated in FIG. 6A.

The inner honeycomb fired body 210 illustrated in FIGS. 6A and 6B have cells 211a and cells 211b longitudinally disposed in parallel with one another with a cell wall 213 therebetween, and a peripheral wall 214 is formed around the inner honeycomb fired body 210.

In the inner honeycomb fired body 210 illustrated in FIGS. 6A and 6B, the cells 211a having a substantially octagonal cross-sectional shape (cross-sectional shape perpendicular to a longitudinal direction) are open at an end portion on the side of one end face of the inner honeycomb fired body 210, and are sealed with a plug material 212a at an end portion on the side of the other end face. In contrast, the cells 211b having a substantially quadrangle (substantially square) cross-sectional shape are sealed with a plug material 212b at an end portion on the side of one end face of the inner honeycomb fired body 210, and are open at an end portion on the side of the other end face.

Therefore, exhaust gases which have flowed into one of the cells 211a surely pass through the cell wall 213 separating the cells 211a and cells 211b, and flow out from another cell 211b. As a result, the cell wall 213 functions as a filter.

In the honeycomb structure according to the second embodiment of the present invention, all of the honeycomb fired bodies not located in the periphery of the ceramic block (namely, inner honeycomb fired bodies) are the center-high-heat-capacity honeycomb fired bodies in each of which the heat capacity per unit volume in the central part of the honeycomb fired body is larger than the heat capacity per unit volume in the peripheral part of the honeycomb fired body.

In the honeycomb structure according to the second embodiment of the present invention, in order to make the heat capacity per unit volume in the central part of the center-high-heat-capacity honeycomb fired body larger than the heat capacity per unit volume in the peripheral part of the center-high-heat-capacity honeycomb fired body, the average thickness of the cell walls in the central part of the center-high-heat-capacity honeycomb fired body is made larger than the average thickness of the cell walls in the peripheral part of the center-high-heat-capacity honeycomb fired body.

More specifically, in the honeycomb structure according to the second embodiment of the present invention, the thickness of the cell wall gradually decreases from the central part to the peripheral part of the center-high-heat-capacity honeycomb fired body.

As illustrated in FIGS. 6A and 6B, in the inner honeycomb fired body 210, the average thickness of the cell walls in the central part of an inner honeycomb fired body 210 is larger than the average thickness of the cell walls in the peripheral part of the inner honeycomb fired body 210.

Specifically, in the inner honeycomb fired body 210 illustrated in FIGS. 6A and 6B, the thickness of cell wall 213 (“Z₂” indicates the thickness of the cell wall in FIG. 6A) gradually decreases from the central part to the peripheral part of the inner honeycomb fired body 210.

Therefore, the inner honeycomb fired body 210 illustrated in FIGS. 6A and 6B is a center-high-heat-capacity honeycomb fired body in which the heat capacity per unit volume in the central part of the honeycomb fired body is larger than the heat capacity per unit volume in the peripheral part of the honeycomb fired body.

In the inner honeycomb fired body 210 illustrated in FIGS. 6A and 6B, a cell located in the center of the cross section of the honeycomb fired body (a cell located in the position “C” in FIG. 6A) is the smallest, and the size of a cell increases as the distance gets farther from the center of the cross section of the honeycomb fired body.

As in the inner honeycomb fired body 210 illustrated in FIGS. 6A and 6B, if the thickness of the cell wall is constant, cells having cross-sectional areas relatively larger than those of the other cells are referred to as large volume cells, and cells having cross-sectional areas relatively smaller than those of the other cells are referred to as small volume cells. Accordingly, in the inner honeycomb fired body 210 illustrated in FIGS. 6A and 6B, the cells 211a having a substantially octagonal cross-sectional shape are large volume cells, and the cells 211b having a substantially quadrangle (substantially square) cross-sectional shape are small volume cells.

In the honeycomb structure according to the second embodiment of the present invention, the ratio of the area of each of the large volume cells in a cross section perpendicular to the longitudinal direction to the area of each of the small volume cells in a cross section perpendicular to the longitudinal direction is preferably from about 1.4 to about 2.8, and more preferably from about 1.5 to about 2.4.

If the area ratio is about 1.4 or more, the difference between the area of each of the large volume cells in a cross section and the area of each of the small volume cells in a cross section tends not to be small, and therefore the effect of providing the large volume cells and small volume cells is more likely to be exerted. In contrast, if the area ratio is about 2.8 or less, the rate of cell walls separating large volume cells tends not to be high. As a result, in the case where the honeycomb structure according to the second embodiment of the present invention is used for collecting PM in exhaust gases, exhaust gases are more likely to pass through the cell walls separating large volume cells, and therefore pressure loss, another required performance as the honeycomb structure, is less likely to increase.

The expression “the ratio of the area of each of the large volume cells in a cross section perpendicular to the longitudinal direction to the area of each of the small volume cells in a cross section perpendicular to the longitudinal direction” used herein refers to a ratio of the cross-sectional area of each of the large volume cells located farthest away from the center of the cross section of the honeycomb fired body to the cross-sectional area of each of the small volume cells located farthest away from the center of the cross section of the honeycomb fired body.

Accordingly, in the inner honeycomb fired body 210 illustrated in FIGS. 6A and 6B, the ratio of the area of each of the large volume cells in a cross section perpendicular to the longitudinal direction to the area of each of the small volume cells in a cross section perpendicular to the longitudinal direction refers to a ratio of the cross-sectional area of each of the large volume cells located in the position “D” to the cross-sectional area of each of the small volume cells located in the position “E”.

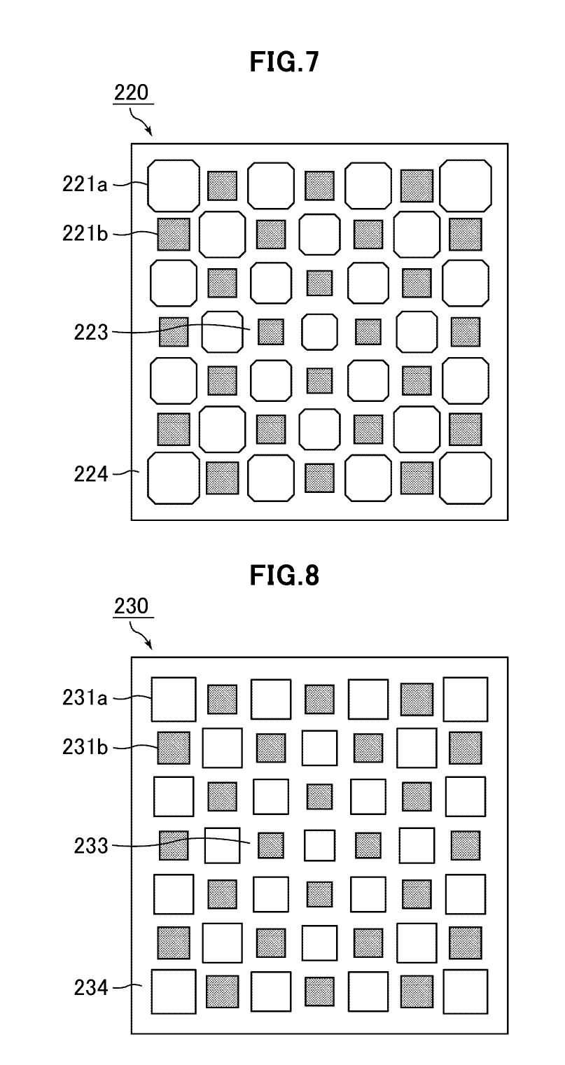

FIG. 7 is a side view schematically illustrating another example of an inner honeycomb fired body in the honeycomb structure of the second embodiment of the present invention.

In an inner honeycomb fired body 220 illustrated in FIG. 7, as in the inner honeycomb fired body 210 illustrated in FIGS. 6A and 6B, a large volume cell 221a and a small volume cell 221b are alternately provided. Each of the large volume cells 221a has a substantially octagonal shape in a cross section, and each of the small volume cells 221b has a substantially quadrangle (substantially square) shape in a cross section.

In the inner honeycomb fired body 220 illustrated in FIG. 7 and the inner honeycomb fired body 210 illustrated in FIGS. 6A and 6B, the ratios of the area of each of the large volume cells in a cross section perpendicular to the longitudinal direction to the area of each of the small volume cells in a cross section perpendicular to the longitudinal direction are different. The area ratio in the inner honeycomb fired body 220 illustrated in FIG. 7 is larger than the area ratio in the inner honeycomb fired body 210 illustrated in FIG. 6A and FIG. 6B.

In the second embodiment of the present invention, each of the large volume cells and small volume cells has a cross-sectional shape such that the cross-sectional area of each of the large volume cells is larger than the cross-section area of each of the small volume cells. Therefore, the cross-sectional shape of each of the large volume cells and small volume cells is not limited to a substantially octagonal shape and a substantially quadrangle shape, respectively, and any cross-sectional shape may be adopted. For example, the following shapes may be employed.

FIG. 8 is a side view schematically illustrating another example of an inner honeycomb fired body in the honeycomb structure of the second embodiment of the present invention.

In an inner honeycomb fired bodies 230 illustrated in FIG. 8, the large volume cells 231a have a substantially quadrangle (substantially square) cross-sectional shape, and the small volume cells 231b have a substantially quadrangle (substantially square) cross-sectional shape.

In the honeycomb structure according to the second embodiment of the present invention, as long as the thickness of the cell wall gradually decreases from the central part to the peripheral part of the center-high-heat-capacity honeycomb fired body, the shape of the cell wall is not limited to shapes illustrated in FIGS. 6, 7, and 8.

In the honeycomb structure according to the second embodiment of the present invention, the preferable average thickness of the cell walls in the central part of the center-high-heat-capacity honeycomb fired body and the preferable average thickness of the cell walls in the peripheral part of the center-high-heat-capacity honeycomb fired body are the same as those of the first embodiment of the present invention.

Next, an outer honeycomb fired body in the honeycomb structure according to the second embodiment of the present invention will be described.

As described in the first embodiment of the present invention, it is sufficient that the outer honeycomb fired body in the honeycomb structure according to the second embodiment of the present invention has a cross-sectional shape excluding part of the inner honeycomb fired body in the honeycomb structure according to the second embodiment of the present invention.

In the honeycomb structure according to the second embodiment of the present invention, the preferable thickness of the peripheral wall in each of the honeycomb fired bodies (inner honeycomb fired bodies and outer honeycomb fired bodies) is the same as that of the first embodiment of the present invention.

In FIG. 6A, “Y₂” represents the thickness of the peripheral wall 214 of the inner honeycomb fired body 210.

In the method for manufacturing the honeycomb structure according to the second embodiment of the present invention, a honeycomb structure can be manufactured as in the first embodiment of the present invention, except that the shape of a die used for extrusion molding is changed and a honeycomb molded body having a predetermined shape is manufactured.

In the second embodiment of the present invention, not only the effects (1) to (5) described in the first embodiment of the present invention but also the following effects can be exerted.

(6) In the honeycomb structure according to the present embodiment, a large number of cells include large volume cells and small volume cells, and each of the large volume cells is larger than each of the small volume cells in a cross section perpendicular to the longitudinal direction.

In the case where the honeycomb structure according to the present embodiment is used for collecting PM in exhaust gases, a large amount of PM tends to be collected in the large volume cells. Therefore, the temperature of the honeycomb fired bodies tends to rise upon burning PM during the regenerating treatment. However, in the honeycomb structure of the present embodiment, since the temperature difference in between the central part and the peripheral part of the center-high-heat-capacity honeycomb fired body tends to be reduced, cracks tend to be prevented.

### Third Embodiment

Hereinafter, a third embodiment that is one embodiment of the present invention will be described.

Inner honeycomb fired bodies and outer honeycomb fired bodies in the honeycomb structure according to the third embodiment of the present invention have the same configurations as those of the inner honeycomb fired bodies and outer honeycomb fired bodies in the honeycomb structure according to the first embodiment of the present invention. In addition, the combination of the inner honeycomb fired bodies and outer honeycomb fired bodies in the ceramic block (honeycomb structure) is the same as that of the first embodiment of the present invention.

Further, in the honeycomb structure according to the third embodiment of the present invention, as in the honeycomb structure according to the first embodiment of the present invention, all of the honeycomb fired bodies not located in the periphery of the ceramic block (namely, inner honeycomb fired bodies) are the center-high-heat-capacity honeycomb fired bodies.

In the first embodiment of the present invention, the thickness of the cell wall gradually decreases from the central part to the peripheral part of the center-high-heat-capacity honeycomb fired body. In contrast, in the third embodiment of the present invention, the thickness of the cell wall continuously decreases from the central part to the peripheral part of the center-high-heat-capacity honeycomb fired body.

First, an inner honeycomb fired body in the honeycomb structure of the third embodiment of the present invention will be described.

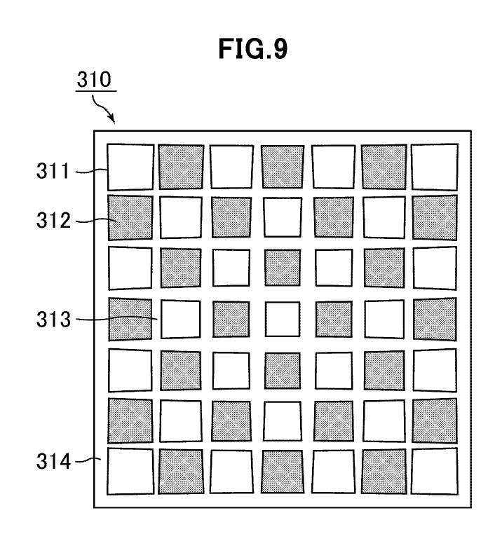

FIG. 9 is a side view schematically illustrating one example of an inner honeycomb fired body in a honeycomb structure of a third embodiment of the present invention.

An inner honeycomb fired body 310 illustrated in FIG. 9 has a large number of cells 311 longitudinally disposed in parallel with one another with a cell wall 313 therebetween, and a peripheral wall 314 is formed around the inner honeycomb fired body 310. In addition, either one end portion of each of the cells 311 is sealed with a plug material 312.

Therefore, exhaust gases which have flowed into one of the cells 311 with an opening on one end face surely pass through the cell wall 313 separating the cells 311, and flow out from another cell 311 with an opening on the other end face. As a result, the cell wall 313 functions as a filter.

In the honeycomb structure according to the third embodiment of the present invention, in order to make the heat capacity per unit volume in the central part of the center-high-heat-capacity honeycomb fired body larger than the heat capacity per unit volume in the peripheral part of the center-high-heat-capacity honeycomb fired body, the average thickness of the cell walls in the central part of the center-high-heat-capacity honeycomb fired body is made larger than the average thickness of the cell walls in the peripheral part of the center-high-heat-capacity honeycomb fired body.

More specifically, in the honeycomb structure according to the third embodiment of the present invention, the thickness of the cell wall continuously decreases from the central part to the peripheral part of the center-high-heat-capacity honeycomb fired body.

As illustrated in FIG. 9, in the inner honeycomb fired body 310, the average thickness of the cell walls in the central part of the inner honeycomb fired body 310 is larger than the average thickness of the cell walls in the peripheral part of the inner honeycomb fired body 310.

Specifically, in the inner honeycomb fired body 310 illustrated in FIG. 9, the thickness of the cell wall 313 continuously decreases from the central part to the peripheral part of the inner honeycomb fired body 310. The cell wall 313 is formed by a curve line, and has a swelling center.

Therefore, the inner honeycomb fired body 310 illustrated in FIG. 9 is a center-high-heat-capacity honeycomb fired body in which the heat capacity per unit volume in the central part of the honeycomb fired body is larger than the heat capacity per unit volume in the peripheral part of the honeycomb fired body.

As illustrated in FIG. 9, all of the cells 311 in the inner honeycomb fired body 310 perpendicular to a longitudinal direction have substantially quadrangle cross-sectional shapes.

In the inner honeycomb fired bodies 310 illustrated in FIG. 9, if the cross-sectional area of each of all the cells is identical to the cross-sectional area of each of the cells located in portions farthest away from the center of the cross section of the honeycomb fired body, the thickness of each of the cell walls is substantially constant, and all of the cells are orderly arranged.

In the honeycomb structure according to the third embodiment of the present invention, as long as the thickness of the cell wall continuously decreases from the central part to the peripheral part of the center-high-heat-capacity honeycomb fired body, the shape of the cell wall is not limited to the shape illustrated in FIG. 9.

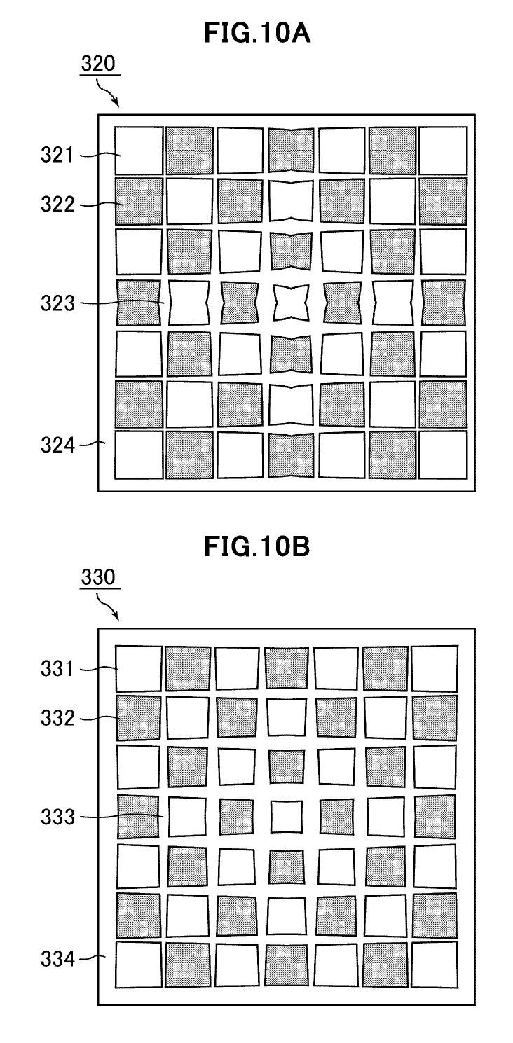

FIGS. 10A and 10B are side views each schematically illustrating another example of an inner honeycomb fired body in the honeycomb structure of the third embodiment of the present invention.

In an inner honeycomb fired body 320 illustrated in FIG. 10A and an inner honeycomb fired body 330 illustrated in FIG. 10B, as in the inner honeycomb fired body 310 illustrated in FIG. 9, the thickness of the cell wall continuously decreases from the central part to the peripheral part of the inner honeycomb fired body 320 or 330.

In the inner honeycomb fired body 320 illustrated in FIG. 10A, a cell wall 323 is formed by a curve line, and has a sharp center.

In the inner honeycomb fired body 330 illustrated in FIG. 10B, a cell wall 333 is formed by a straight line, and has a substantially rhombic shape.

In the honeycomb structure according to the third embodiment of the present invention, the preferable average thickness of the cell walls in the central part of the center-high-heat-capacity honeycomb fired body and the preferable average thickness of the cell walls in the peripheral part of the center-high-heat-capacity honeycomb fired body are the same as those of the first embodiment of the present invention.

Next, an outer honeycomb fired body in the honeycomb structure according to the third embodiment of the present invention will be described.

As described in the first embodiment of the present invention, it is sufficient that the outer honeycomb fired body in the honeycomb structure according to the third embodiment of the present invention has a cross-sectional shape excluding part of the inner honeycomb fired body in the honeycomb structure according to the third embodiment of the present invention.

In the honeycomb structure according to the third embodiment of the present invention, the preferable thickness of the peripheral wall in each of the honeycomb fired bodies (inner honeycomb fired bodies and outer honeycomb fired bodies) is the same as that of the first embodiment of the present invention.

In the honeycomb structure according to the third embodiment of the present invention, the cross sections of the cells provided in the inner honeycomb fired bodies and the outer honeycomb fired bodies may be all substantially quadrangle shapes, or may be a shape made of large volume cells and small volume cells as in the second embodiment of the present invention.

In the honeycomb structure according to the third embodiment of the present invention, the cross sections of the cells are preferably all substantially quadrangle shapes in terms of easier manufacture of the honeycomb molded body.

In the method for manufacturing the honeycomb structure according to the third embodiment of the present invention, a honeycomb structure can be manufactured as in the first embodiment of the present invention, except that the shape of a die used for extrusion molding is changed and a honeycomb molded body having a predetermined shape is manufactured.

In the third embodiment of the present invention, not only the effects (1) to (3), and (5) described in the first embodiment of the present invention but also the following effects can be exerted.

(7) In the honeycomb structure of the present embodiment, the thickness of the cell wall continuously decreases from the central part to the peripheral part of the center-high-heat-capacity honeycomb fired body.

In the honeycomb structure of the present embodiment, the heat capacity per unit volume in the center-high-heat-capacity honeycomb fired body tends to be continuously decreased from the central part to the peripheral part of the center-high-heat-capacity honeycomb fired body. Therefore, heat tends to be transferred smoothly from the central part to the peripheral part of the center-high-heat-capacity honeycomb fired body.

### Fourth Embodiment

Hereinafter, a fourth embodiment that is one embodiment of the present invention will be described.

Inner honeycomb fired bodies and outer honeycomb fired bodies in the honeycomb structure according to the fourth embodiment of the present invention have the same configurations as those of the inner honeycomb fired bodies and outer honeycomb fired bodies in the honeycomb structure according to the first embodiment of the present invention. In addition, the combination of the inner honeycomb fired bodies and outer honeycomb fired bodies in the ceramic block (honeycomb structure) is the same as that of the first embodiment of the present invention.

Further, in the honeycomb structure according to the fourth embodiment of the present invention, as in the honeycomb structure according to the first embodiment of the present invention, all of the honeycomb fired bodies not located in the periphery of the ceramic block (namely, inner honeycomb fired bodies) are the center-high-heat-capacity honeycomb fired bodies.

In the first embodiment of the present invention, the thickness of the cell wall gradually decreases from the central part to the peripheral part of the center-high-heat-capacity honeycomb fired body. In contrast, in the fourth embodiment of the present invention, cell walls located in the outermost part of the center-high-heat-capacity honeycomb fired body are thinner than cell walls other than the cell walls located in the outermost part of the center-high-heat-capacity honeycomb fired body.

First, an outer honeycomb fired body in the honeycomb structure of the fourth embodiment of the present invention will be described.

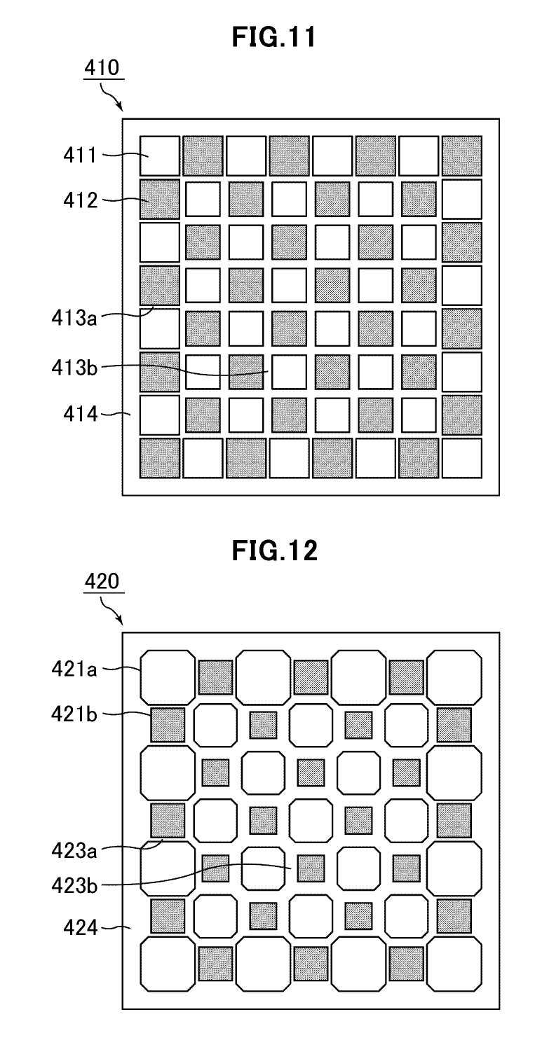

FIG. 11 is a side view schematically illustrating one example of an inner honeycomb fired body in a honeycomb structure of a fourth embodiment of the present invention.

An inner honeycomb fired body 410 illustrated in FIG. 11 has a large number of cells 411 longitudinally disposed in parallel with one another with a cell wall 413a or 413b therebetween, and a peripheral wall 414 is formed around the inner honeycomb fired body 410. In addition, either one end portion of each of the cells 411 is sealed with a plug material 412.

Therefore, exhaust gases which have flowed into one of the cells 411 with an opening on one end face surely pass through the cell wall 413a or 413b separating the cells 411, and flow out from another cell 411 with an opening on the other end face. As a result, the cell wall 413a or 413b functions as a filter.

In the honeycomb structure according to the fourth embodiment of the present invention, in order to make the heat capacity per unit volume in the central part of the center-high-heat-capacity honeycomb fired body larger than the heat capacity per unit volume in the peripheral part of the center-high-heat-capacity honeycomb fired body, the average thickness of the cell walls in the central part of the center-high-heat-capacity honeycomb fired body is made larger than the average thickness of the cell walls in the peripheral part of the center-high-heat-capacity honeycomb fired body.

More specifically, in the honeycomb structure according to the fourth embodiment of the present invention, cell walls located in the outermost part of the center-high-heat-capacity honeycomb fired body are thinner than cell walls other than the cell walls located in the outermost part of the center-high-heat-capacity honeycomb fired body.

As illustrated in FIG. 11, in the inner honeycomb fired body 410, the average thickness of the cell walls in the central part of the inner honeycomb fired body 410 is larger than the average thickness of the cell walls in the peripheral part of the inner honeycomb fired body 410.

Specifically, in the inner honeycomb fired body 410 illustrated in FIG. 11, the thickness of the cell walls 413a located in the outermost part of the inner honeycomb fired body 410 is smaller than the thickness of the cell walls 413b other than the cell walls 413a located in the outermost part of the inner honeycomb fired body 410. The thickness of the cell walls 413b located in a part other than the cell walls 413a located in the outermost part of the inner honeycomb fired body 410 is substantially constant.

Therefore, the inner honeycomb fired body 410 illustrated in FIG. 11 is a center-high-heat-capacity honeycomb fired body in which the heat capacity per unit volume in the central part of the honeycomb fired body is larger than the heat capacity per unit volume in the peripheral part of the honeycomb fired body.

As illustrated in FIG. 11, in the inner honeycomb fired body 410, each of the cells 411 has a substantially quadrangle (substantially square) shape in a cross section perpendicular to the longitudinal direction of the cells 411.

In the inner honeycomb fired body 410 illustrated in FIG. 11, each of the cells located in the outermost periphery of the honeycomb fired body is larger than each of the cells located in a part other than the outermost periphery of the honeycomb fired body.

In the honeycomb structure according to the fourth embodiment of the present invention, as long as cell walls located in the outermost part of the center-high-heat-capacity honeycomb fired body are thinner than cell walls other than the cell walls located in the outermost part of the center-high-heat-capacity honeycomb fired body, the shape of the cell wall is not limited to the shape illustrated in FIG. 11.

In the honeycomb structure according to the fourth embodiment of the present invention, the preferable average thickness of the cell walls in the central part of the center-high-heat-capacity honeycomb fired body and the preferable average thickness of the cell walls in the peripheral part of the center-high-heat-capacity honeycomb fired body are the same as those of the first embodiment of the present invention.

Next, an outer honeycomb fired body in the honeycomb structure according to the fourth embodiment of the present invention will be described.

As described in the first embodiment of the present invention, it is sufficient that the outer honeycomb fired body in the honeycomb structure according to the fourth embodiment of the present invention has a cross-sectional shape excluding part of the inner honeycomb fired body in the honeycomb structure according to the fourth embodiment of the present invention.

In the honeycomb structure according to the fourth embodiment of the present invention, the preferable thickness of the peripheral wall in each of the honeycomb fired bodies (inner honeycomb fired bodies and outer honeycomb fired bodies) is the same as that of the first embodiment of the present invention.

In the honeycomb structure according to the fourth embodiment of the present invention, the cross sections of the cells provided in the inner honeycomb fired bodies and the outer honeycomb fired bodies may be all substantially quadrangle (substantially square) shapes, or may be a shape made of large volume cells and small volume cells as in the second embodiment of the present invention.

FIG. 12 is a side view schematically illustrating another example of an inner honeycomb fired body in the honeycomb structure of the fourth embodiment of the present invention.

In an inner honeycomb fired body 420 illustrated in FIG. 12, a large volume cell 421a and a small volume cell 421b are alternately provided. Each of the large volume cells 421a has a substantially octagonal shape in a cross section, and each of the small volume cells 421b has a substantially quadrangle (substantially square) shape in a cross section. The thickness of the cell walls 423a located in the outermost part of the inner honeycomb fired body 420 is smaller than that of the cell walls 423b other than the cell walls 423a located in the outermost part of the inner honeycomb fired body 420.

In the method for manufacturing the honeycomb structure according to the fourth embodiment of the present invention, a honeycomb structure can be manufactured as in the first embodiment of the present invention, except that the shape of a die used for extrusion molding is changed and a honeycomb molded body having a predetermined shape is manufactured.

In the fourth embodiment of the present invention, not only the effects (1) to (3), and (5) described in the first embodiment of the present invention but also the following effects can be exerted.

(8) In the honeycomb structure according to the present embodiment, cell walls located in the outermost part of the center-high-heat-capacity honeycomb fired body are thinner than cell walls other than the cell walls located in the outermost part of the center-high-heat-capacity honeycomb fired body.

Since the temperature difference in between the central part and the peripheral part of the center-high-heat-capacity honeycomb fired body tends to be more reduced even in the honeycomb structure containing the center-high-heat-capacity honeycomb fired body having such a configuration, cracks tend to be prevented.

### EXAMPLE

Hereinafter, examples are given for more specifically describing the first to fourth embodiments of the present invention. However, the present invention is not limited only to these examples.

### (Manufacture of Honeycomb Fired Body)

First, honeycomb fired bodies 1 to 11 having different thicknesses of cell walls were manufactured.

### (Manufacture of Honeycomb Fired Body 1)

First, 54.6% by weight of a silicon carbide coarse powder having an average particle size of 22 μm and 23.4% by weight of a silicon carbide fine powder having an average particle size of 0.5 μm were mixed. To the resulting mixture, 4.3% by weight of an organic binder (methylcellulose), 2.6% by weight of a lubricant (UNILUB, manufactured by NOF Corporation), 1.2% by weight of glycerin, and 13.9% by weight of water were added, and then kneaded to prepare a wet mixture. The obtained wet mixture was extrusion-molded.

In this process, there was manufactured a raw honeycomb molded body having approximately the same shape as that of the inner honeycomb fired body 210 illustrated in FIGS. 6A and 6B with cells not sealed.

Next, the raw honeycomb molded bodies were dried with a microwave drying apparatus to obtain dried honeycomb molded bodies. Predetermined cells of the dried honeycomb molded bodies were sealed by filling the cells with a plug material paste. The wet mixture was used as the plug material paste. Thereafter, the dried honeycomb molded bodies, which have predetermined cells filled with the plug material paste, were dried with a drying apparatus again.

Subsequently, the dried honeycomb molded bodies having cells sealed were degreased at 400° C., and then fired at 2200° C. under normal pressure argon atmosphere for three hours.

In this manner, a honeycomb fired body was manufactured. The honeycomb fired body manufactured in the above processes was a honeycomb fired body 1.

The honeycomb fired body 1 includes a porous silicon carbide sintered body and has a porosity of 42%, an average pore size of 9 μm, a size of 34.3 mm×34.3 mm×200 mm, the number of cells (cell density) of 24×24 pcs/unit, and a thickness of the peripheral wall of 0.3 mm. The honeycomb fired body 1 has large volume cells and small volume cells, and the ratio of the area of each of the large volume cells in a cross section perpendicular to the longitudinal direction to the area of each of the small volume cells in a cross section perpendicular to the longitudinal direction is 1.55.

The thickness of the cell wall in the honeycomb fired body 1 was measured by the following method.

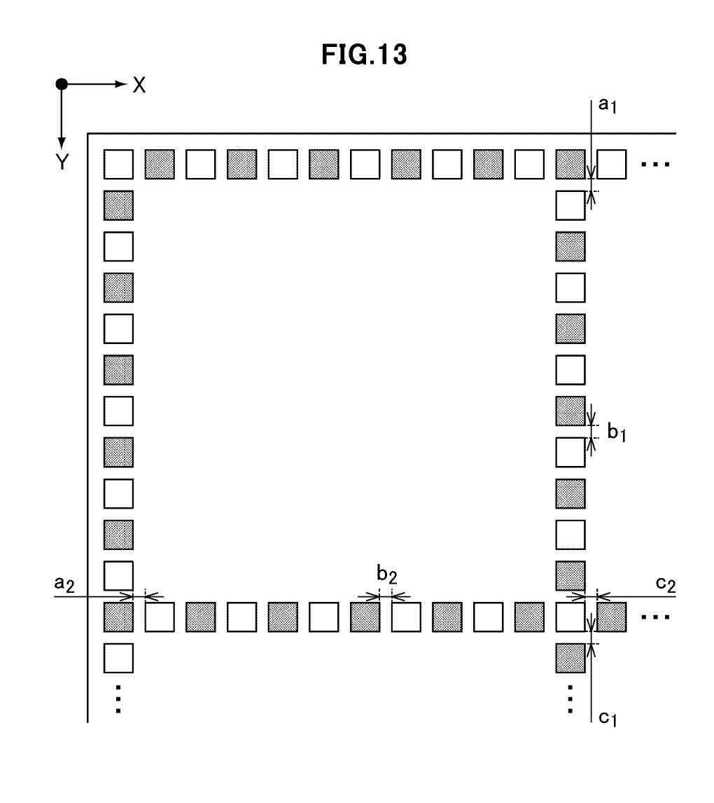

FIG. 13 is a schematic view for explaining a method of measuring the thickness of a cell wall in a honeycomb fired body in each of the examples and comparative examples. In FIG. 13, the cross-sectional shapes of all the cells are fixed to be a quadrangle (square), and the thicknesses of all the cell walls are assumed to be constant in order to plainly describe a method for measuring the thickness of the cell walls. In addition, only some cells are described in FIG. 13.

First, provided that one corner of the honeycomb fired body is set to be an original point and the peripheral wall in the honeycomb fired body is set to be an X-axis and a Y-axis in the manufactured honeycomb fired body, a two-dimensional orthogonal coordinate system in which the X-axis and the Y-axis intersects are mutually orthogonal is assumed. Here, the cells formed in the honeycomb fired body 1 are given coordinates of (X,Y)=(1, 1), (1, 2), . . . , (1, 24), (2, 1), (2, 2), . . . , (2, 24), (3, 1), . . . , (11, 24), (12, 1), (12, 2), . . . , (12, 24), (13, 1), . . . , (23, 24), (24, 1) (24, 2) . . . (24, 24).

Next, the thickness of each of the cell walls is measured with an optical microscope (produced by Nikon Corporation, measuring microscope MM-40) in the cell line located in X=12 and Y=12. Specifically, in the cell line located in X=12, the thickness “a₁” of the cell wall between cells (12, 1) and (12, 2), the thickness “b₁” of the cell wall between cells (12, 7) and (12, 8), the thickness “c₁” of the cell wall between cells (12, 12) and (12, 13), the thickness “d₁” (not illustrated) of the cell wall between cells (12, 17) and (12, 18), and the thickness “e₁” (not illustrated) of the cell wall between cells (12, 23) and (12, 24) are measured. In the cell line located in Y=12, the thickness “a₂” of the cell wall between cells (1, 12) and (2, 12), the thickness “b₂” of the cell wall between cells (7, 12) and (8, 12), the thickness “c₂” of the cell wall between cells (12, 12) and (13, 12), the thickness “d₂” (not illustrated) of the cell wall between cells (17, 12) and (18, 12), and the thickness “e₂” (not illustrated) of the cell wall between cells (23, 12) and (24, 12) are measured.

The average of “a₁” and “a₂”, the average of “b₁” and “b₂”, the average of “c₁” and “c₂”, the average of “d₁” and “d₂”, the average of “e₁” and “e₂” are obtained, and are “a”, “b”, “c”, “d”, and “e”, respectively.

As a result, the cell walls in the honeycomb fired body 1 have thicknesses of a=0.095 mm, b=0.100 mm, c=0.105 mm, d=0.100 mm, and e=0.095 mm.

### (Manufacture of Honeycomb Fired Bodies 2 to 11)

In the process of manufacturing the honeycomb fired body 1, the shape of a die used in the molding process was changed, and honeycomb fired bodies 2 to 11 having cell walls with different thicknesses were manufactured.

Upon manufacturing honeycomb fired bodies 2 to 6, raw honeycomb molded bodies which had a shape similar to that of the inner honeycomb fired body 210 illustrated in FIGS. 6A and 6B and whose cells were not sealed were manufactured.

Upon manufacturing a honeycomb fired body 7, a raw honeycomb molded body which had a shape similar to that of the inner honeycomb fired body 420 illustrated in FIG. 12 and whose cells were not sealed was manufactured.

Upon manufacturing honeycomb fired bodies 8 to 10, raw honeycomb molded bodies which had cell walls with a constant thickness and whose cells were not sealed were manufactured.

Upon manufacturing a honeycomb fired body 11, a raw honeycomb molded body which had an inverted shape of that of the inner honeycomb fired body 210 illustrated in FIGS. 6A and 6B and whose cells were not sealed was manufactured. That is, a raw honeycomb molded body having a shape in which the thickness of the cell wall gradually increases from the central part to the peripheral part of the honeycomb fired body was manufactured.

The honeycomb fired bodies 2 to 11 include a porous silicon carbide sintered body and has a porosity of 42%, an average pore size of 9 μm, a size of 34.3 mm×34.3 mm×200 mm, the number of cells (cell density) of 24×24 pcs/unit, a thickness of the peripheral wall of 0.3 mm. Each of the honeycomb fired bodies 2 to 11 has large volume cells and small volume cells, and the ratio of the area of each of the large volume cells in a cross section perpendicular to the longitudinal direction to the area of each of the small volume cells in a cross section perpendicular to the longitudinal direction is 1.55.

The cell walls in the honeycomb fired body 2 have thicknesses of a=0.143 mm, b=0.150 mm, c=0.157 mm, d=0.150 mm, and e=0.143 mm.

The cell walls in the honeycomb fired body 3 have thicknesses of a=0.166 mm, b=0.175 mm, c=0.184 mm, d=0.175 mm, and e=0.166 mm.

The cell wall in the honeycomb fired body 4 have thicknesses of a=0.170 mm, b=0.175 mm, c=0.180 mm, d=0.175 mm, and e=0.170 mm.

The cell wall in the honeycomb fired body 5 have thicknesses of a=0.173 mm, b=0.175 mm, c=0.177 mm, d=0.175 mm, and e=0.173 mm.

The cell wall in the honeycomb fired body 6 have thicknesses of a=0.190 mm, b=0.200 mm, c=0.210 mm, d=0.200 mm, and e=0.190 mm.

The cell wall in the honeycomb fired body 7 have thicknesses of a=0.166 mm, b=0.179 mm, c=0.179 mm, d=0.179 mm, and e=0.166 mm.

The cell wall in the honeycomb fired body 8 have thicknesses of a=0.100 mm, b=0.100 mm, c=0.100 mm, d=0.100 mm, and e=0.100 mm.

The cell wall in the honeycomb fired body 9 have thicknesses of a=0.175 mm, b=0.175 mm, c=0.175 mm, d=0.175 mm, and e=0.175 mm.

The cell wall in the honeycomb fired body 10 have thicknesses of a=0.200 mm, b=0.200 mm, c=0.200 mm, d=0.200 mm, and e=0.200 mm.

The cell wall in the honeycomb fired body 11 have thicknesses of a=0.185 mm, b=0.175 mm, c=0.165 mm, d=0.175 mm, and e=0.185 mm.

### (Manufacture of Honeycomb Structure)

A honeycomb structure was manufactured with each of the honeycomb fired bodies 1 to 11.

### Example 1

An adhesive paste was applied to predetermined side faces of the honeycomb fired bodies 1, and 36 pieces (six pieces in length×six pieces in breadth) of the honeycomb fired bodies 1 were combined with one another with the adhesive paste interposed therebetween. In this manner, an aggregate of the honeycomb fired bodies was manufactured.

The aggregate of the honeycomb fired bodies was heated at 180° C. for 20 minutes to dry and solidify the adhesive paste. In this manner, a rectangular pillar-shaped ceramic block having the adhesive layer of 1 mm in thickness was manufactured.

Here, as the adhesive paste, an adhesive paste having the following composition was used. The adhesive paste contains 30.0% by weight of silicon carbide particles having an average particle size of 0.6 μm, 21.4% by weight of silica sol (solids content: 30% by weight), 8.0% by weight of carboxymethyl cellulose, and 40.6% by weight of water.

Subsequently, the periphery of the rectangular pillar-shaped ceramic block was cut with a diamond cutter. In this manner, a round pillar-shaped ceramic block having a diameter of 198.5 mm was manufactured.

Next, a peripheral coating material paste was applied to the peripheral part of the round pillar-shaped ceramic block, and the peripheral coating material paste was heated and solidified at 120° C. In this manner, a peripheral coat layer was formed around the peripheral part of the ceramic block. Here, the adhesive paste was used as the peripheral coating material paste.

Through the above processes, a round pillar-shaped honeycomb structure having a diameter of 200 mm×a length of 200 mm was manufactured.

### Examples 2 to 7

Honeycomb structured bodies of Examples 2 to 7 were manufactured as in Example 1 by using each of the honeycomb fired bodies 2 to 7.

### Comparative Examples 1 to 4

Honeycomb structured bodies of Comparative Examples 1 to 4 were manufactured as in Example 1 by using each of the honeycomb fired bodies 8 to 11.

### (Durability Test)

The honeycomb structured bodies manufactured in Examples 1 to 7 and Comparative Examples 1 to 4 were subjected to a durability test by the following method.

First, a holding sealing material was wound around each of the honeycomb structured bodies manufactured in Examples 1 to 7 and Comparative Examples 1 to 4. Then, the resulting honeycomb structure was press-fitted into a cylindrical casing (metal shell) so that an exhaust gas purifying apparatus was manufactured. Here, the holding sealing material is mat-like and made of alumina-silica inorganic fibers, and has a thickness of 8 mm.

The end portion on the exhaust gas inlet side of the exhaust gas purifying apparatus was connected to an introduction pipe coupled to a 6.4-L diesel engine. Further, the end portion on the exhaust gas outlet side of the exhaust gas purifying apparatus was connected to an exhaust pipe coupled to the outside.

Subsequently, the engine was driven at the number of revolutions of 3000 min⁻¹ and a torque of 50 Nm so that exhaust gases from the engine were allowed to pass through the honeycomb structure.

After the engine had been driven until the amount of PM captured per one liter of the honeycomb structure reached the amount (amount of captured PM: 31 to 50 g/L) described in Table 1, PM was burned by post-injection.

A condition for the post injection was set such that a central temperature of the honeycomb structure became almost constant at 600° C. during one minute after the post injection was started. After the post injection, occurrence of cracks in the honeycomb structure was visually observed.

In the column of “cracks” in Table 1, the case where cracks occurred in the honeycomb structure after the post injection was represented as “present” while the case where no cracks occurred in the honeycomb structure after the post injection was represented as “absent”.

Table 1 summarizes the honeycomb fired bodies used, the thickness of the cell walls in the honeycomb fired bodies, and the results of the durability test in the honeycomb structured bodies according to Examples 1 to 7 and Comparative Examples 1 to 4.

TABLE 1

| | | | | | | | Durability test | |
|---|---|---|---|---|---|---|---|---|
| | Honeycomb | Thickness of cell wall in honeycomb fired body (mm) | | | | | Amount of | |
| | fired body | a | b | c | d | e | captured PM (g/L) | Cracks |
| Example 1 | 1 | 0.095 | 0.100 | 0.105 | 0.100 | 0.095 | 31 | Absent |
| Example 2 | 2 | 0.143 | 0.150 | 0.157 | 0.150 | 0.143 | 41 | Absent |
| Example 3 | 3 | 0.166 | 0.175 | 0.184 | 0.175 | 0.166 | 44 | Absent |
| Example 4 | 4 | 0.170 | 0.175 | 0.180 | 0.175 | 0.170 | 44 | Absent |
| Example 5 | 5 | 0.173 | 0.175 | 0.177 | 0.175 | 0.173 | 44 | Absent |
| Example 6 | 6 | 0.190 | 0.200 | 0.210 | 0.200 | 0.190 | 50 | Absent |
| Example 7 | 7 | 0.166 | 0.179 | 0.179 | 0.179 | 0.166 | 44 | Absent |
| Comparative | 8 | 0.100 | 0.100 | 0.100 | 0.100 | 0.100 | 31 | Present |
| Example 1 | | | | | | | | |
| Comparative | 9 | 0.175 | 0.175 | 0.175 | 0.175 | 0.175 | 44 | Present |
| Example 2 | | | | | | | | |
| Comparative | 10 | 0.200 | 0.200 | 0.200 | 0.200 | 0.200 | 50 | Present |
| Example 3 | | | | | | | | |
| Comparative | 11 | 0.185 | 0.175 | 0.165 | 0.175 | 0.185 | 44 | Present |
| Example 4 | | | | | | | | |

As in Examples 1 to 7, when the thickness of the cell wall in the central part of the honeycomb fired body in the honeycomb structure was larger than the thickness of the cell wall in the peripheral part of the honeycomb fired body, cracks did not occur in the honeycomb structure after the post injection.

In contrast, when the thickness of the cell wall in the honeycomb structure is constant as in Comparative Examples 1 to 3, and when the thickness of the cell wall in the central part of the honeycomb fired body in the honeycomb structure was smaller than the thickness of the cell wall in the peripheral part of the honeycomb fired body as in Comparative Example 4, cracks occurred in the honeycomb structure after the post injection.

As thus described, when the average thickness of the cell walls in the central part of the honeycomb fired body in the honeycomb structure is larger than the average thickness of the cell walls in the peripheral part of the honeycomb fired body, cracks resulting from the temperature difference in between the central part and the peripheral part of the honeycomb fired body tends to be presumably prevented. It is because when the average thickness of the cell walls in the central part of the honeycomb fired body is larger than the average thickness of the cell walls in the peripheral part of the honeycomb fired body, the heat capacity per unit volume in the central part of the honeycomb fired body tends to be presumably larger than the heat capacity per unit volume in the peripheral part of the honeycomb fired body.

### Other Embodiments

In the honeycomb structured bodies according to the first to fourth embodiments of the present invention, all of the honeycomb fired bodies not located in the periphery of the ceramic block (namely, inner honeycomb fired bodies) are the center-high-heat-capacity honeycomb fired bodies.

However, in the honeycomb structure according to the embodiments of the present invention, it is sufficient that at least one of the multiple honeycomb fired bodies in the honeycomb structure is a center-high-heat-capacity honeycomb fired body. The number and the position of the center-high-heat-capacity honeycomb fired bodies in the honeycomb structure is not particularly limited.

Therefore, not the inner honeycomb fired bodies but the outer honeycomb fired bodies may be center-high-heat-capacity honeycomb fired bodies in the honeycomb structure.

In the honeycomb structured bodies according to the first to fourth embodiments of the present invention, the honeycomb fired bodies (namely, outer honeycomb fired bodies) located in the periphery of the ceramic block are not center-high-heat-capacity honeycomb fired bodies.

However, in the honeycomb structure according to the embodiments of the present invention, all the honeycomb fired bodies in the honeycomb structure may be center-high-heat-capacity honeycomb fired bodies.

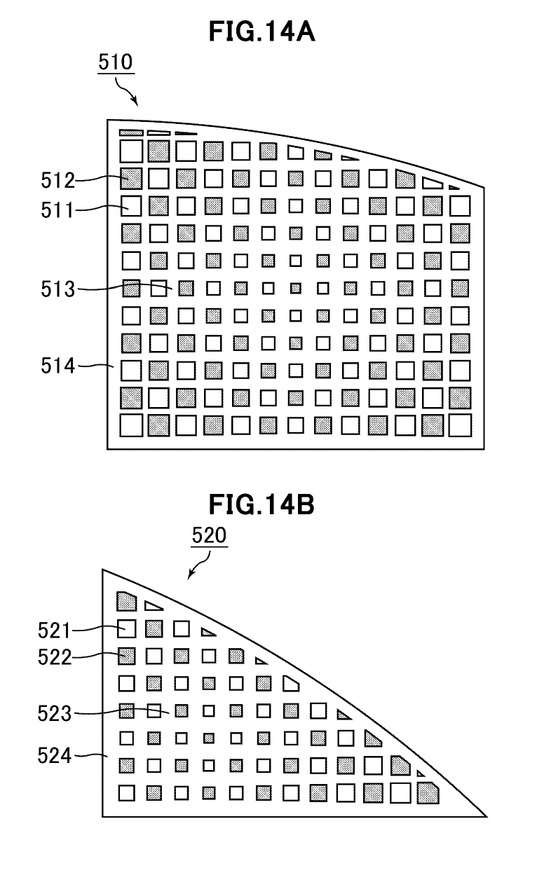

Specifically, the honeycomb structure according to the embodiments of the present invention may include inner honeycomb fired bodies 110 illustrated in FIG. 2A, FIG. 2B, and FIG. 4, outer honeycomb fired bodies 510 illustrated in FIG. 14A, and outer honeycomb fired bodies 520 illustrated in FIG. 14B.

FIGS. 14A and 14B are side views each schematically illustrating one example of an outer honeycomb fired body in a honeycomb structure of another embodiment of the present invention.

The outer honeycomb fired body 510 illustrated in FIG. 14A and the outer honeycomb fired body 520 illustrated in FIG. 14B are modifications of the outer honeycomb fired body 120 illustrated in FIG. 5A and the outer honeycomb fired body 130 illustrated in FIG. 5B, respectively.

In the outer honeycomb fired body 510 illustrated in FIG. 14A and the outer honeycomb fired body 520 illustrated in FIG. 14B, the thickness of a cell wall 513 or 523 gradually decreases from the central part to the peripheral part of the outer honeycomb fired bodies 510 and 520. Specifically, in the outer honeycomb fired body 510 illustrated in FIG. 14A and the outer honeycomb fired body 520 illustrated in FIG. 14B, a cell located in the center of the cross section of the honeycomb fired body is the smallest, and the size of a cell increases as the distance gets farther from the center of the cross section of the honeycomb fired body.

In order to manufacture a honeycomb structure having the above configuration, a honeycomb molded body may be prepared with a die that corresponds to the outer honeycomb fired body 510 illustrated in FIG. 14A and the outer honeycomb fired body 520 illustrated in FIG. 14B.

In the honeycomb structure according to the embodiments of the present invention, it is preferable to manufacture a honeycomb molded body with the same die in consideration of manufacture efficiency of the honeycomb structure. Accordingly, the honeycomb structure according to the embodiments of the present invention is preferably manufactured from a ceramic block in which multiple honeycomb fired bodies having the same cell structure are combined with one another.

In the inner honeycomb fired body, which is a center-high-heat-capacity honeycomb fired body, in the honeycomb structured bodies according to the first and second embodiments of the present invention, a cell located in the center of the cross section of the honeycomb fired body is the smallest, and the size of a cell increases as the distance gets farther from the center of the cross section of the honeycomb fired body.

However, in the honeycomb structured bodies according to the first and second embodiments of the present invention, it is sufficient that the thickness of the cell wall gradually decreases from the central part to the peripheral part of the center-high-heat-capacity honeycomb fired body. For example, the following cell structure (the shape and arrangement of cells) may be employed.

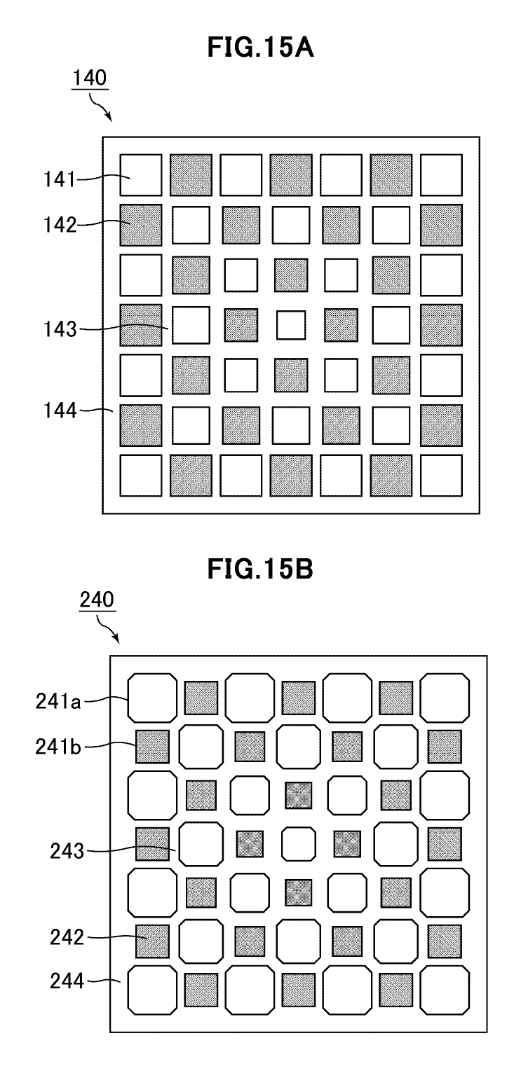

FIG. 15A is a side view schematically illustrating another example of an inner honeycomb fired body in the honeycomb structure of the first embodiment of the present invention. FIG. 15B is a side view schematically illustrating another example of an inner honeycomb fired body in the honeycomb structure of the second embodiment of the present invention.

An inner honeycomb fired body 140 illustrated in FIG. 15A is a modification of the inner honeycomb fired body 110 illustrated in FIG. 4, and an inner honeycomb fired body 240 illustrated in FIG. 15B is a modification of the inner honeycomb fired body 210 illustrated in FIGS. 6A and 6B.

In the inner honeycomb fired body 140 illustrated in FIG. 15A and the inner honeycomb fired body 240 illustrated in FIG. 15B, a cell located in the center of the cross section of the honeycomb fired body is the smallest, and the size of cells increases as cell groups surrounding the smallest cell get farther from the smallest cell.

In the honeycomb fired body in the honeycomb structure according to the embodiments of the present invention, when the large number of cells include large volume cells and small volume cells, the configurations of the large volume cells and small volume cells are not limited to the configurations described in the preceding embodiments.

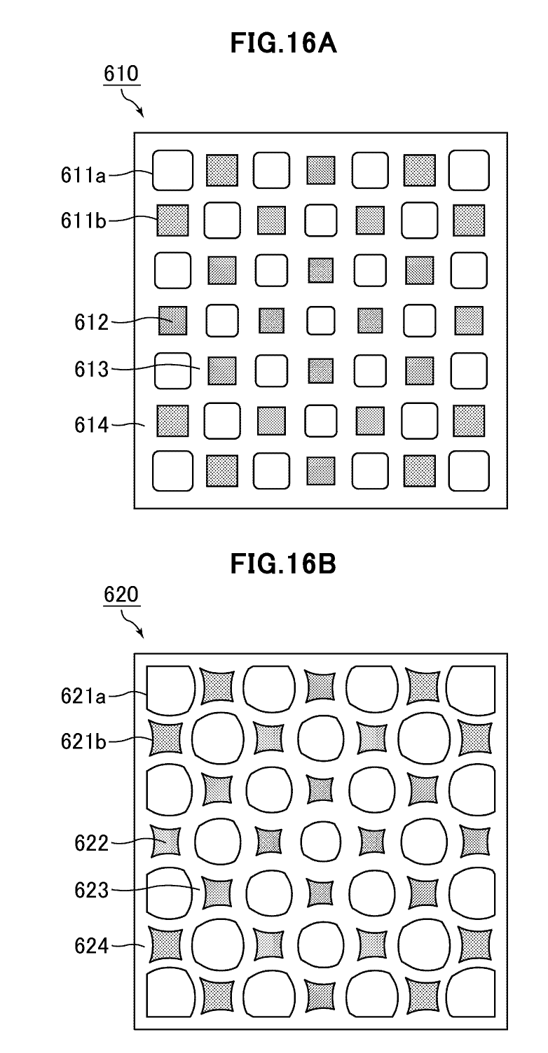

FIGS. 16A and 16B are side views each schematically illustrating one example of an inner honeycomb fired body in a honeycomb structure of another embodiment of the present invention.

FIGS. 16A and 16B are each a side view seen from one end face of the inner honeycomb fired body, namely, the end face on the side where the small volume cells are sealed.

Other embodiments of the cross-sectional shapes of the large volume cell and the small volume cell are described with reference to FIGS. 16A and 16B.

In an inner honeycomb fired body 610 illustrated in FIG. 16A, each of large volume cells 611a in a cross section perpendicular to the longitudinal direction has a substantially quadrangle shape in which portions corresponding to corner portions have substantially arc shapes, and each of small volume cells 611b in a cross section perpendicular to the longitudinal direction has a substantially quadrangle shape.

Each of the small volume cells 611b, as well as the large volume cells 611a, in a cross section perpendicular to the longitudinal direction may have a substantially quadrangle shape in which portions corresponding to corner portions have substantially arc shapes.

In an inner honeycomb fired body 620 illustrated in FIG. 16B, large volume cells 621a and small volume cells 621b are cells whose cell walls 623 are formed by curve lines in a cross section perpendicular to the longitudinal direction.

Namely, the cross-sectional shapes of cell walls 623 indicated by solid lines are formed by curve lines in FIG. 16B.

The large volume cells 621a have cross-sectional shapes in which cell walls 623 project from the center toward the outside of the cell cross section. In contrast, the small volume cells 621b have cross-sectional shapes in which cell walls 623 project from the outside toward the center of the cross section of the cell.

The cell walls 623 have “wave” shapes undulating horizontally and vertically in a cross section of the inner honeycomb fired body. The tops of the waves of the adjacent cell walls 623 (maximum amplitude of sinusoid) in small volume cells are most proximate to each other so that the large volume cells 621a having a cross-sectional shape expanding outwardly and the small volume cells 621b recessing inwardly may be formed. The amplitude of the waves may or may not be substantially constant. In particular, substantially constant waves are preferable.

In the outer honeycomb fired body, the large volume cells and the small volume cells may have cross sections as illustrated in FIG. 16A or 16B. Also, the outer honeycomb fired body may have a cross-sectional shape excluding part of the inner honeycomb fired body illustrated in FIG. 16A or 16B.

Thus, in the center-high-heat-capacity honeycomb fired bodies in the honeycomb structure according to the embodiments of the present invention, cell structures (the shape and arrangement of cells) of various honeycomb fired bodies may be employed. That is, in the honeycomb structured bodies according to the embodiments of the present invention, as long as the average thickness of the cell walls in the central part of the center-high-heat-capacity honeycomb fired body is larger than the average thickness of the cell walls in the peripheral part of the center-high-heat-capacity honeycomb fired body, the shape of the cell wall and the cell structure are not particularly limited.

Therefore, the shape of the cell wall in the same center-high-heat-capacity honeycomb fired body may be a combination of the shape of the cell wall whose thickness gradually decreases from the central part to the peripheral part of the center-high-heat-capacity honeycomb fired body and the shape of the cell wall whose thickness continuously decreases from the central part to the peripheral part of the center-high-heat-capacity honeycomb fired body.

In addition, the shape of the cell wall in the same center-high-heat-capacity honeycomb fired body may be a combination of the shapes of the cell walls and cell structures described in aforementioned embodiments.

Further, though cells are formed in the center of the cross section of the honeycomb fired bodies described in aforementioned embodiments, cells may not be formed in the center of the cross section of the honeycomb fired bodies.

The honeycomb structured bodies each made of 32 pieces of honeycomb fired bodies were described as examples in the first to fourth embodiments of the present invention. The shape and the number of honeycomb fired bodies in the honeycomb structure according to the embodiments of the present invention is not particularly limited.

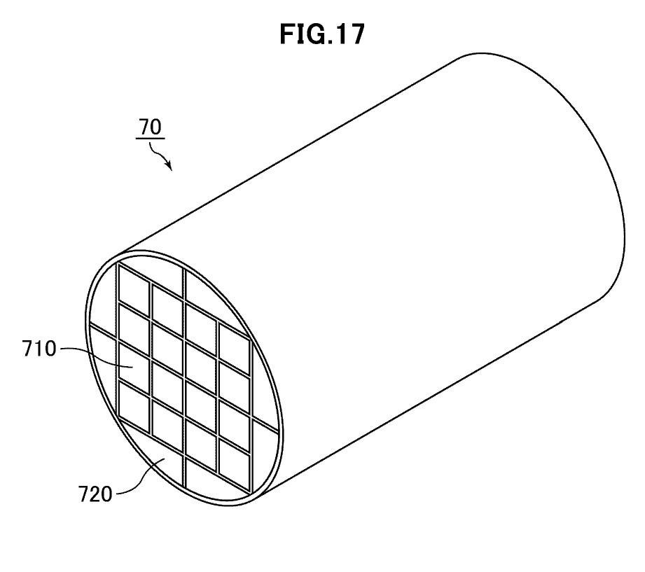

FIG. 17 is a perspective view schematically illustrating one example of a honeycomb structure of another embodiment of the present invention.

A honeycomb structure 70 illustrated in FIG. 17 is made of 16 pieces of inner honeycomb fired bodies 710 and 8 pieces of outer honeycomb fired bodies 720.

The honeycomb structure 70 illustrated in FIG. 17 has the same configuration as that of the honeycomb structure 10 illustrated in FIGS. 1A and 1B, except that an outer honeycomb fired body 720 has a different cross-sectional shape. The outer honeycomb fired body 720 illustrated in FIG. 17 has a cross-sectional shape surrounded by two line segments (long line segment and short line segment) and one substantially arc shape. The angle formed by the two line segments is substantially 90°. The length of the long line segment of the outer honeycomb fired body 720 is not particularly limited, and is preferably a length corresponding to 2 pieces of the inner honeycomb fired bodies 710 (including the thickness of an adhesive layer).

As the cell structures of the inner honeycomb fired bodies 710 and the outer honeycomb fired bodies 720 illustrated in FIG. 17, any cell structure described in the aforementioned embodiments may be employed.

Upon manufacturing a ceramic block in the honeycomb structure according to the embodiments of the present invention, multiple kinds of honeycomb fired bodies having different cross-sectional shapes are manufactured, and a combination of the multiple kinds of honeycomb fired bodies leads to manufacture of a ceramic block in which multiple honeycomb fired bodies are combined with one another by interposing an adhesive layer. In this case, the periphery cutting process can be omitted.

In order to manufacture the honeycomb structure 10 illustrated in FIGS. 1A and 1B, the following three kinds of honeycomb fired bodies having different cross-sectional shapes are manufactured. The first honeycomb fired body has a cross-sectional shape (substantially quadrangle shape) surrounded by four straight lines. The second honeycomb fired body has a cross-sectional shape surrounded by two straight lines and one substantially arc shape. The third honeycomb fired body has a cross-sectional shape surrounded by three straight lines and one substantially arc shape. A substantially round pillar-shaped ceramic block can be manufactured by combining 16 pieces of the first honeycomb fired bodies, 8 pieces of the second honeycomb fired bodies, and 8 pieces of the third honeycomb fired bodies.

Also, in order to manufacture the honeycomb structure 70 illustrated in FIG. 17, the following two kinds of honeycomb fired bodies having different cross-sectional shapes are manufactured. The first honeycomb fired body has a cross-sectional shape (substantially quadrangle shape) surrounded by four straight lines. The second honeycomb fired body has a cross-sectional shape surrounded by two straight lines and one substantially arc shape. A substantially round pillar-shaped ceramic block can be manufactured by combining 16 pieces of the first honeycomb fired bodies and 8 pieces of the second honeycomb fired bodies.

Here, each of the honeycomb fired bodies having different cross-sectional shapes can be manufactured by changing the shape of a die to be used in extrusion molding.

Examples of the combining process upon manufacturing the honeycomb structure according to the embodiments of the present invention may include a method in which an adhesive paste is applied to a side face of each of the honeycomb fired bodies; a method in which each of the honeycomb fired bodies is temporally fixed in a molding frame having substantially the same shape as the shape of a ceramic block (or an aggregate of honeycomb fired bodies) to be manufactured and an adhesive paste is injected into each gap between the honeycomb fired bodies; and the like.

The shape of the honeycomb structure according to the embodiments of the present invention is not limited to a substantially round pillar shape, and may be any pillar shape such as a substantially cylindroid shape, a substantially pillar shape with a racetrack end face, and a substantially polygonal pillar shape.

In the honeycomb structure according to the embodiments of the present invention, the end portion of the cells may not be sealed without a plug material provided in the cells. In this case, when a catalyst is supported on the cell walls, the honeycomb structure functions as a catalyst supporting carrier for converting toxic gas components such as CO, NC, or NOx in exhaust gases.

In the honeycomb fired bodies in the honeycomb structure according to the embodiments of the present invention, the thickness of the peripheral wall may be substantially the same as or larger than the thickness of the thickest cell wall. The thickness of the peripheral wall is preferably larger than the thickness of the thickest cell wall in terms of the strength of the honeycomb fired bodies.

In the case where the peripheral wall is thicker than the cell wall in the honeycomb fired body, the peripheral wall is preferably about 1.3 times to about 3.0 times as thick as the thickest cell wall.

In the honeycomb structure according to the embodiments of the present invention used as a filter, the porosity of the honeycomb fired body included in the honeycomb structure is not particularly limited and is preferably in a range from about 35% to about 60%.

A porosity of the honeycomb fired body of about 35% or more tends not to cause clogging of the honeycomb fired body. In contrast, a porosity of the honeycomb fired body of about 60% or less tends not to lower the strength of the honeycomb fired body, and therefore the honeycomb fired body tends not to be broken.

In the honeycomb structure according to the embodiments of the present invention used as a filter, the honeycomb fired body included in the honeycomb structure preferably has an average pore size of from about 5 μm to about 30 μm.

An average pore size of the honeycomb fired body of about 5 μm or more tends not to cause clogging of the honeycomb fired body. In contrast, an average pore size of the honeycomb fired body of about 30 μm or less tends not to allow particulates to pass through the pores of the honeycomb fired body. In such a case, the honeycomb fired body tends to capture particulates, and the honeycomb structure tends to function as a filter.

The porosity and the pore size can be measured by the conventionally known methods such as mercury porosimetry.

The cell density in a cross section perpendicular to the longitudinal direction of the honeycomb fired body in the honeycomb structure according to the embodiments of the present invention is not particularly limited, and the lower limit thereof is preferably about 31.0 pcs/cm² (about 200 pcs/inch²) and the upper limit thereof is preferably about 93.0 pcs/cm² (about 600 pcs/inch²). The lower limit of the cell density is more preferably about 38.8 pcs/cm² (about 250 pcs/inch²) and the upper limit thereof is more preferably about 77.5 pcs/cm² (about 500 pcs/inch²).

The thickness of the thickest cell wall in the honeycomb fired body included in the honeycomb structure according to the embodiments of the present invention is not particularly limited, and is preferably from about 0.1 mm to about 0.4 mm.

If the thickest cell wall has a thickness of about 0.1 mm or more, the thickness of cell wall is not too thin, and the strength of the honeycomb fired body tends to be maintained. In contrast, the thickest cell wall having a thickness of about 0.4 mm or less tends not to cause a rise in pressure loss of the honeycomb structure.

In the honeycomb structure according to the embodiments of the present invention, the shape of each cell in the honeycomb fired body in a cross section perpendicular to the longitudinal direction of the honeycomb fired body is not particularly limited, and may be any shape such as a substantially circular shape, a substantially elliptical shape, a substantially quadrangle shape, a substantially pentagonal shape, a substantially hexagonal shape, a substantially trapezoidal shape, and a substantially octagonal shape. Or alternatively, various shapes of cells may be present in combination.

The main component of the material of the honeycomb fired body included in the honeycomb structure according to the embodiments of the present invention is not limited to silicon carbide or silicon-bonded silicon carbide, and may be other ceramic materials. The other ceramic materials refer to ceramic powder including: ceramic nitrides such as aluminum nitride, silicon nitride, boron nitride, and titanium nitride; ceramic carbides such as zirconium carbide, titanium carbide, tantalum carbide, and tungsten carbide; and ceramic oxides such as cordierite and aluminium titanate.

Among these, non-oxide ceramics are preferable and silicon carbide or silicon-bonded silicon carbide is particularly preferable because of its excellent heat resistance, mechanical strength, thermal conductivity, and the like.

The organic binder in the wet mixture used for manufacturing the honeycomb fired body included in the honeycomb structure according to the embodiments of the present invention is not particularly limited. Examples thereof include methylcellulose, carboxy methylcellulose, hydroxy ethylcellulose, polyethylene glycol, and the like. Methylcellulose is preferable among these. A blending amount of the organic binder is usually preferably in a range from about 1 part by weight to about 10 parts by weight relative to 100 parts by weight of the ceramic powder.

The plasticizer in the wet mixture is not particularly limited, and examples thereof include glycerin and the like.

The lubricant in the wet mixture is not particularly limited, and examples thereof include polyoxyalkylene-based compounds such as polyoxyethylene alkyl ether and polyoxypropylene alkyl ether.

Specific examples of the lubricant include polyoxyethylene monobutyl ether, polyoxypropylene monobutyl ether, and the like.

Moreover, the plasticizer and the lubricant may not be contained in the wet mixture in some cases.

In addition, a dispersant solution may be used upon preparing a wet mixture. Examples of the dispersant solution include water, an organic solvent such as benzene, alcohol such as methanol, and the like.

Furthermore, a molding aid may be added to the wet mixture.

The molding aid is not particularly limited, and examples thereof include ethylene glycol, dextrin, fatty acid, fatty acid soap, polyalcohol, and the like.

Furthermore, a pore-forming agent such as balloons that are fine hollow spheres including oxide-based ceramics, spherical acrylic particles, and graphite may be added to the wet mixture, if necessary.

The balloons are not particularly limited, and examples thereof include alumina balloon, glass micro balloon, shirasu balloon, fly ash balloon (FA balloon), mullite balloon, and the like. Alumina balloon is desirable among these.

Examples of the inorganic binder in the adhesive paste and the peripheral coating material paste include silica sol, alumina sol, and the like. Each of these materials may be used alone, or two or more of these may be used in combination. Silica sol is preferable among the inorganic binders.

Example of the organic binder in the adhesive paste and the peripheral coating material paste include polyvinyl alcohol, methyl cellulose, ethyl cellulose, carboxymethyl cellulose, and the like. Each of these materials may be used alone, or two or more of these may be used in combination. Carboxymethyl cellulose is preferable among the organic binders.

Examples of the inorganic particles in the adhesive paste and the peripheral coating material paste include carbide particles, nitride particles, and the like. Specific examples thereof include inorganic particles made from silicon carbide, silicon nitride, boron nitride, and the like. Each of these may be used alone, or two or more of these may be used in combination. Among the inorganic particles, silicon carbide particles are preferable due to their superior thermal conductivity.

Examples of the inorganic fibers and/or whisker in the adhesive paste and the peripheral coating material paste include inorganic fibers and/or whisker made from silica-alumina, mullite, alumina, silica, and the like. Each of these may be used alone or two or more kinds of these may be used in combination. Alumina fibers are desirable among the inorganic fibers. The inorganic fibers may be biosoluble fibers.

Furthermore, a pore-forming agent such as balloons that are fine hollow spheres including oxide-based ceramics, spherical acrylic particles, and graphite may be added to the adhesive paste and the peripheral coating material paste, if necessary. The balloons are not particularly limited, and examples thereof include alumina balloon, glass micro balloon, shirasu balloon, fly ash balloon (FA balloon), mullite balloon, and the like. Alumina balloon is desirable among these.

A catalyst for purifying exhaust gases may be supported on the cell walls of the honeycomb fired body in the honeycomb structure according to the embodiments of the present invention. Preferable examples of the catalyst include noble metals such as platinum, palladium, and rhodium. Other examples of the catalyst include alkali metals such as potassium and sodium, alkaline earth metals such as barium, and zeolite. Each of these catalysts may be used alone, or two or more of these may be used in combination.

The honeycomb structure according to the embodiments of the present invention includes an essential feature that at least one of the multiple honeycomb fired bodies is a center-high-heat-capacity honeycomb fired body in which the heat capacity per unit volume in the central part of the honeycomb fired body is larger than the heat capacity per unit volume in the peripheral part of the honeycomb fired body.

Desired effects can be exerted when such an essential feature is appropriately combined with various configurations described in detail in the first to fourth embodiments and other embodiments (for example, the shape of the honeycomb fired body in the honeycomb structure, the shape of the cell wall in the honey comb fired body, the cell structure of the honeycomb fired body, and the process for manufacturing the honeycomb structure).

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb structure comprising:
a plurality of honeycomb fired bodies each of which is combined with one another by an adhesive layer interposed between the honeycomb fired bodies to form a ceramic body;
each of the honeycomb fired bodies having a peripheral wall around each of the honeycomb fired bodies and having a plurality of cells each of which extends along a longitudinal direction of the honeycomb fired body and in parallel with one another, the cells being separated from one another with a cell wall disposed between the cells; and
the ceramic body including at least one center-high-heat-capacity honeycomb fired body which is a honeycomb fired body having a heat capacity per unit volume in a central part in a plane perpendicular to the longitudinal direction larger than a heat capacity per unit volume in a peripheral part in the plane.

2. The honeycomb structure according to claim 1,
wherein
an average thickness of the cell walls in the central part of the center-high-heat-capacity honeycomb fired body is larger than an average thickness of the cell walls in the peripheral part of the center-high-heat-capacity honeycomb fired body.

3. The honeycomb structure according to claim 2,
wherein
the average thickness of the cell walls in the central part of the center-high-heat-capacity honeycomb fired body is from about 0.10 mm to about 0.20 mm, and
the average thickness of the cell walls in the peripheral part of the center-high-heat-capacity honeycomb fired body is from about 90% to about 98% of the average thickness of the cell walls in the central part of the center-high-heat-capacity honeycomb fired body.

4. The honeycomb structure according to claim 2,
wherein
the thickness of the cell wall gradually decreases from the central part to the peripheral part of the center-high-heat-capacity honeycomb fired body.

5. The honeycomb structure according to claim 2,
wherein
the thickness of the cell wall continuously decreases from the central part to the peripheral part of the center-high-heat-capacity honeycomb fired body.

6. The honeycomb structure according to claim 2,
wherein
cell walls located in an outermost part in the plane of the center-high-heat-capacity honeycomb fired body are thinner than cell walls other than the cell walls located in the outermost part in the plane of the center-high-heat-capacity honeycomb fired body.

7. The honeycomb structure according to claim 1,
wherein
a thickness of the peripheral wall is from about 0.20 mm to about 0.50 mm in each of the plurality of honeycomb fired bodies.

8. The honeycomb structure according to claim 1,
wherein
in each of the plurality of honeycomb fired bodies, the plurality of cells include a plurality of large volume cells and a plurality of small volume cells, and
each of the large volume cells has an area larger than an area of each of the small volume cells in a cross section perpendicular to the longitudinal direction.

9. The honeycomb structure according to claim 8,
wherein
each of the large volume cells has a substantially octagonal shape in the cross section perpendicular to the longitudinal direction, and
each of the small volume cells has a substantially quadrangle shape in the cross section perpendicular to the longitudinal direction.

10. The honeycomb structure according to claim 8,
wherein
each of the large volume cells has a substantially quadrangle shape in the cross section perpendicular to the longitudinal direction, and
each of the small volume cells has a substantially quadrangle shape in the cross section perpendicular to the longitudinal direction.

11. The honeycomb structure according to claim 8,
wherein
a cell wall to define each of the large volume cells and the small volume cells has a shape having a curve line in the cross section perpendicular to the longitudinal direction.

12. The honeycomb structure according to claim 8,
wherein
a ratio of the area of each of the large volume cells in the cross section perpendicular to the longitudinal direction to the area of each of the small volume cells in the cross section perpendicular to the longitudinal direction is from about 1.4 to about 2.8.

13. The honeycomb structure according to claim 1,
wherein
all of the honeycomb fired bodies not located in a periphery of the ceramic block are the center-high-heat-capacity honeycomb fired bodies.

14. The honeycomb structure according to claim 1,
wherein
all of the plurality of honeycomb fired bodies are the center-high-heat-capacity honeycomb fired bodies.

15. The honeycomb structure according to claim 1,
wherein
each of the plurality of cells is alternately sealed at either end portion in the longitudinal direction in each of the plurality of honeycomb fired bodies.

16. The honeycomb structure according to claim 1,
wherein
a peripheral coat layer is provided on a periphery of the ceramic block.

17. The honeycomb structure according to claim 1,
wherein
the honeycomb fired body has a porous body including silicon carbide or silicon-bonded silicon carbide.

18. The honeycomb structure according to claim 1,
wherein
16 pieces of outer honeycomb fired bodies are positioned to form a periphery of the ceramic block and 16 pieces of inner honeycomb fired bodies are positioned inward of the outer honeycomb fired bodies, and a total of 32 pieces of the honeycomb fired bodies are combined with one another by interposing the adhesive layers.

19. The honeycomb structure according to claim 3,
wherein
the average thickness of the cell walls in the central part of the center-high-heat-capacity honeycomb fired body is from about 0.12 mm to about 0.18 mm.

20. The honeycomb structure according to claim 3,
wherein
the average thickness of the cell walls in the peripheral part of the center-high-heat-capacity honeycomb fired body is from about 92% to about 96% of the average thickness of the cell walls in the central part of the center-high-heat-capacity honeycomb fired body.

21. The honeycomb structure according to claim 5,
wherein
the cell wall has a curve line and a swelling center in a cross section perpendicular to the longitudinal direction.

22. The honeycomb structure according to claim 5,
wherein
the cell wall has a curve line and a sharp center in a cross section perpendicular to the longitudinal direction.

23. The honeycomb structure according to claim 5,
wherein
the cell wall has a straight line and a substantially rhombic shape in a cross section perpendicular to the longitudinal direction.

24. The honeycomb structure according to claim 1,
wherein
the honeycomb fired bodies in a periphery of the ceramic block are the center-high-heat-capacity honeycomb fired bodies.

25. The honeycomb structure according to claim 1,
wherein
the honeycomb fired bodies in a periphery of the ceramic block are not the center-high-heat-capacity honeycomb fired bodies.

26. The honeycomb structure according to claim 8,
wherein
each of the large volume cells in the cross section perpendicular to the longitudinal direction has a substantially quadrangle shape in which corner portions have substantially arc shapes, and
each of the small volume cells in the cross section perpendicular to the longitudinal direction has a substantially quadrangle shape.

27. The honeycomb structure according to claim 8,
wherein
each of the large volume cells and the small volume cells in the cross section perpendicular to the longitudinal direction have a substantially quadrangle shape in which corner portions have substantially arc shapes.

28. The honeycomb structure according to claim 1,
wherein
the thickness of the peripheral wall of the honeycomb fired body is larger than a thickness of a thickest cell wall.

29. The honeycomb structure according to claim 28,
wherein
the peripheral wall of the honeycomb fired body is about 1.3 times to about 3.0 times as thick as the thickest cell wall.

30. The honeycomb structure according to claim 1,
wherein
a catalyst is provided on the cell walls.
